(19) United States
(12) Patent Application Publication
(10) Pub. No.: US 2026/0340437 A1
(43) Pub. Date: Oct. 29, 2026

(54) SYSTEM AND METHOD FOR SMART CONSTRUCTION PROJECTS EXECUTION AND MANAGEMENT USING ARTIFICIAL INTELLIGENCE (AI) MESH-BASED INTELLIGENT STRUCTURAL FABRIC UNITS

(71) Applicant: SLATE TECHNOLOGIES, INC., San Mateo, CA (US)

(72) Inventor: Senthil Manickavasagam KUMAR, Pleasanton, CA (US)

(73) Assignee: SLATE TECHNOLOGIES, INC., San Mateo, CA (US)

(21) Appl. No.: 19/193,537

(22) Filed: Apr. 29, 2025

(51) Int. Cl. G06N 5/022

(52) U.S. Cl. CPC G06N 5/022

(57) ABSTRACT

A method for smart construction projects execution and management using advanced Artificial Intelligence mesh-based intelligence structural fabric units is disclosed. The method includes receiving a user request corresponding to a project objective associated with a construction project, applying ensembles of machine learning models to each of a plurality of data feeds to generate knowledge units based on a user request, assembling knowledge units into a knowledge graph assembly, adaptively updating a structural fabric unit to generate a morphed structural fabric unit based on the knowledge derivative assembly, and notifying the morphed structural fabric unit in one or more formats to a client computing device via an output interface.

### FIELD OF THE INVENTION

The present disclosure relates generally to Artificial Intelligence (AI) and machine learning (ML)-based systems. In particular, the disclosure relates to the implementation and use of advanced machine intelligence, smart knowledge assembly, AI, ML, and cognitive systems and methods for managing Architecture, Engineering, and Construction (AEC) projects using AI mesh-based intelligent structural fabric units.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In the Architecture, Engineering, and Construction (AEC) field, management of projects has always been a complex and multi-layered set of tasks. The AEC field involves optimization, by a machine and/or a human, of organization and execution of AEC projects. Over the course of time, a construction project may include various job functions, for example, schedule establishment, design validation, design modification, inspection, and the like, during different construction phases. One or more such construction phases can exhibit different levels of dependencies on one another. For example, in certain cases, one or more construction phases may be independent phases that do not depend on any other construction phase. Or, the one or more construction phases can occur concurrently, either as a whole or in part. In any case, for every AEC project, optimization is required to be performed during different moments of time and during different construction phases.

Conventional solutions in the AEC field for managing the AEC projects recommend a static and reusable set of activities for a given task that are based on either manual or rule-based approaches. However, such solutions fail to comprehend real-time inputs and dynamic variations associated with the AEC projects and thus, may not be able to provide optimal process recommendations for each construction phase. Also, in certain cases, impact factors for an AEC project may be numerous and varied. Such impact factors, while known, are near impractical to predict, plan and accommodate until the impact factors happen or are likely to happen with some degree of certainty. Complexity of each construction phase in the AEC project may be intensified due to involvement of different types of entities, such as materials, suppliers, weather conditions, to name a few. Additionally, such conventional software solutions fail to ascertain sufficient knowledge and understanding of the various aspects related to the AEC projects to comprehend and interpret the various metrics (such as productivity metrics) for further enrichment.

Accordingly, there is a need for technical solutions that address the needs described above, as well as other inefficiencies of the state of the art. Accordingly, there is a need in the art to smartly manage AEC projects.

### SUMMARY OF THE INVENTION

In some embodiments, systems that provide smart and adaptive intelligence aided solutions for optimally managing AEC projects during various construction phases or processes, for example, strategies, design validation, design formulation, and inspection for AEC projects, are described.

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below. Embodiments of an AI-based system and a corresponding method are disclosed that address at least some of the above-described challenges and issues.

Embodiments of an AI-based system and a corresponding method are disclosed that address at least some of the above challenges and issues. In some embodiments, the subject matter of the present disclosure is a computer-implemented method for managing construction projects using knowledge graph-based structural fabric units. The method includes receiving a user request corresponding to a project objective associated with a construction project in a construction environment, obtaining a plurality of data feeds from a plurality of disparate data sources for a construction phase based on the project objective and a user intent identified from the user request, applying a plurality of ensembles of machine learning models to each of the plurality of data feeds to generate a plurality of knowledge units based on the user request, wherein each of the plurality of ensembles of the machine learning models is trained using data related to the construction project, wherein the plurality of knowledge units are assembled in a knowledge graph assembly, adaptively updating a structural fabric unit to generate a morphed structural fabric unit based on the knowledge graph assembly, wherein the structural fabric unit corresponds to semantically organized real-world entities associated with the construction project, and notifying the morphed structural fabric unit in one or more formats to a client computing device via an output interface.

In an embodiment, the subject matter of the present disclosure may relate to a system for managing construction projects using knowledge graph-based structural fabric units. The system may include a controller configured to receive a user request corresponding to a project objective associated with a construction project in a construction environment, obtain a plurality of data feeds from a plurality of disparate data sources for a construction phase based on the project objective and a user intent identified from the user request, apply a plurality of ensembles of machine learning models to each of the plurality of data feeds to generate a plurality of knowledge units based on the user request, wherein each of the plurality of ensembles of the machine learning models is trained using data related to the construction project, wherein the plurality of knowledge units are assembled in a knowledge graph assembly, adaptively update a structural fabric unit to generate a morphed structural fabric unit based on the knowledge graph assembly, wherein the structural fabric unit corresponds to semantically organized real-world entities associated with the construction project, and notify the morphed structural fabric unit in one or more formats to a client computing device via an output interface.

In an embodiment, the subject matter of the present disclosure may relate to non-transitory computer-readable storage medium, having stored thereon a computer-executable program which, when executed by at least one processor, causes the at least one processor to perform the steps detailed above.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the invention will become apparent by reference to the detailed description of disclosed embodiments when considered in conjunction with the drawings:

FIG. 1 illustrates an example network computing system for managing AEC projects using AI mesh-based intelligent structural fabric units, according to some embodiments.

FIG. 2A illustrates an example computational system for managing AEC projects using AI mesh-based intelligent structural fabric units, according to some embodiments.

FIG. 2B illustrates an example computational system for model ensemble, according to some embodiments.

FIG. 2C illustrates an example computational system for the intelligent structural fabric unit module, in accordance with the disclosed embodiments.

FIG. 2D illustrates an example computational system for a recommendation engine, in accordance with the disclosed embodiments.

FIGS. 3A to 3B illustrate a project mesh structure illustrating a plurality of intelligent structural fabric units powering an AEC project, according to some embodiments.

FIG. 4A illustrates a method for managing AEC projects using AI mesh-based intelligent structural fabric units, according to some embodiments.

FIG. 4B illustrates another method for generating intelligent structural fabric units, according to some embodiments.

FIG. 5 illustrates a block diagram of an example computer system, according to some embodiments.

FIG. 6 illustrates a block diagram of a basic software system employed for controlling the operation of computer system, according to some embodiments.

### DETAILED DESCRIPTION

The following detailed description is presented to enable a person skilled in the art to make and use the disclosure. For purposes of explanation, specific details are set forth to provide an understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein are able to be applied to other embodiments and applications without departing from the scope of the disclosure. The present disclosure is not intended to be limited to the embodiments shown but is to be accorded with the widest possible scope consistent with the principles and features disclosed herein.

Typically, in an AEC environment, conventional construction management systems provide recommendations in the form of one or more sets of activities for one or more job functions or tasks at different points in time and during different construction phases. For example, for a job task “Dig a foundation,” a conventional system may recommend an exemplary set of activities: “1) Prepare land; 2) Dig a trench; and 3) pour concrete.” The sets of activities are reusable and static artifacts, and hence not adaptive according to the AEC environment from where such sets of activities are invoked. There are required smart and adaptive systems that can comprehend real-time inputs and dynamic variations associated with the AEC projects and thus, are able to provide optimal process recommendations for each phase.

Also, in certain cases, impact factors, while known, are near impractical to predict, plan and accommodate until the impact factors come to pass or are likely to come to pass with some degree of certainty. In such cases, conventional systems are not able to provide dynamic recommendations. For such speculative impact factors, conventional solutions are highly prone to situational variance. Again, there are required smart systems that can consider all such impact factors, analyze and contextually interpret the same, and able to provide intelligent recommendations for any construction phase at any point in time.

Further, conventional systems fail to ascertain sufficient knowledge and understanding of the various aspects related to the AEC projects. It would be beneficial to evaluate, comprehend, and interpret the various metrics (such as productivity metrics and temporal metrics) associated with the AEC projects. Accordingly, the knowledge structures, such as core knowledge segments and knowledge snippets derived from data feeds, may be enriched with metadata, that in turn provide smart, relevant, contextual, and relatable recommendations for actionable entities for a construction schedule.

To achieve its objectives, firstly the disclosed system imbibes knowledge both from the domain specificity, meaning the project-related data warehouse, artifacts, different types of constraints that have worked in the past, and in addition to that, the disclosed system relates to the domain knowledge that exists everywhere else in the world that is made available to it via public sources or otherwise. The disclosed system relates the intrinsic knowledge and knowledge from the outside world together with the real-time inputs associated with the AEC environment and generates intelligent recommendations by producing dynamic artifacts. Such kinds of recommendations that so far were not possible in a machine-learning setting are now possible as the disclosed system starts thinking about and articulating such kinds of needs. In particular, the disclosed system goes beyond manual and rule-based conventional approaches and provides adaptive intelligent constructs, i.e. intelligent structural fabric units, that are self-composing and can be utilized at any time in any construction phase. The intelligent structural fabric units are objective driven, self-curating, smart entities that are essentially tailored to the construction phase, productivity metrics and AEC environment associated with the AEC project.

Clearly, the disclosed system is able to improve and manage AEC projects more efficiently by addressing the challenges faced with conventional systems, as well as other inefficiencies of the state of the art.

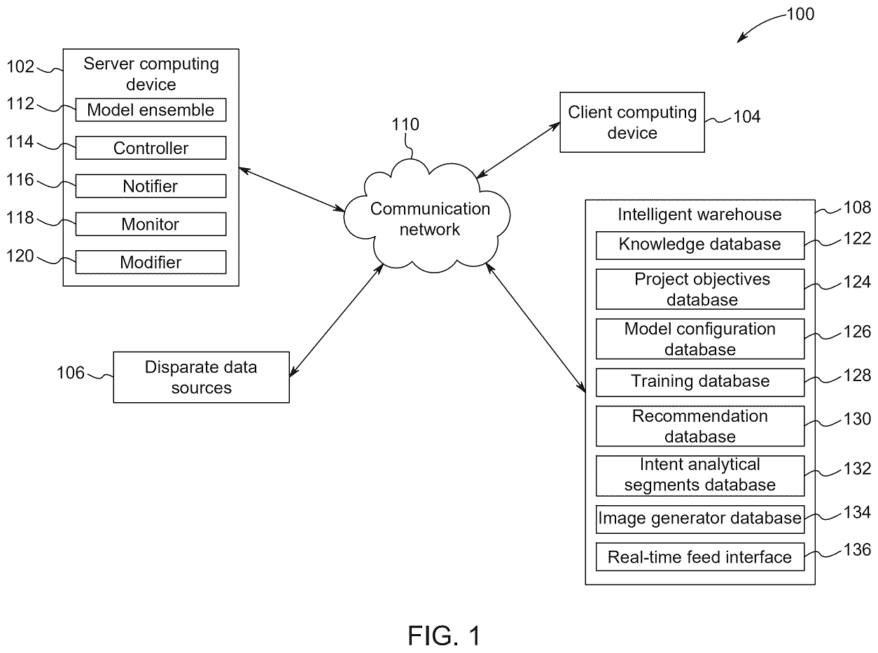

Various embodiments of the methods and systems are described in more detail with reference to FIGS. 1 to 6. Other embodiments, aspects, and features will become apparent from the remainder of the disclosure as a whole.

Certain terms and phrases have been used throughout the present disclosure and will have the following meanings in the context of the ongoing disclosure.

A “network” refers to a series of nodes or network elements that are interconnected via communication paths. In an example, the network is able to include any number of software and/or hardware elements coupled to each other to establish the communication paths and route data/traffic via the established communication paths. In accordance with the embodiments of the present disclosure, the network is able to include, but is not limited to, the Internet, a local area network (LAN), a wide area network (WAN), an Internet of things (IoT) network, and/or a wireless network. Further, in accordance with the embodiments of the present disclosure, the network is able to comprise, but is not limited to, copper transmission cables, optical transmission fibers, wireless transmission, routers, firewalls, switches, gateway computers, and/or edge servers.

A “device” refers to an apparatus using electrical, mechanical, or thermal power and having several parts, each with a definite function and together performing a particular task. In accordance with the embodiments of the present disclosure, a device is able to include, but is not limited to, one or more IoT devices. Further, one or more IoT devices are able to be related to, but are not limited to, connected appliances, smart home security systems, autonomous farming equipment, wearable health monitors, smart factory equipment, wireless inventory trackers, ultra-high speed wireless internet, biometric cybersecurity scanners, and shipping containers and logistics tracking. The term “device” in some embodiments, is able to be referred to as equipment or machine without departing from the scope of the ongoing description.

A “processor” is able to include a module that performs the methods described in accordance with the embodiments of the present disclosure. The module of the processor is able to be programmed into integrated circuits of the processor, or loaded in memory, storage device, or network, or combinations thereof.

“Database” refers to an organized collection of structured information, or data, typically stored electronically in a computer system.

“Data feed” is a mechanism for users to receive updated data from data sources. The Data feed is commonly used in real-time applications in point-to-point settings as well as on the World Wide Web.

“Knowledge graph assembly” may refer to a data model that represents knowledge in a structured and interconnected manner. A knowledge graph assembly is a graph database that captures information in the form of entities (nodes) and relationships (edges) between such entities. Each entity and relationship in the knowledge graph assembly may be associated with attributes allowing for rich and meaningful representations of data.

“Data fabric” may refer to an architecture or a framework designed to provide a unified and consistent way to access, manage, and share data across multiple environments, locations, and formats. A data fabric strategy may be configured to break down data silos, improve data collaboration, and accelerate data-driven insights and innovation.

“Data mesh” may refer to a distributed architecture and an organizational-level framework that leverages self-serve design by which data ownership is allocated to domain-oriented groups or business units that serve, own, and manage data as a product.

“Machine learning” refers to a study of computer algorithms that are able to improve automatically through experience and by the use of data. Machine learning algorithms build a model based at least on sample data, known as “training data,” in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that are able to learn from and make predictions on data. Such algorithms function by making data-driven predictions or decisions, through building a mathematical model from input data. The input data used to build the model are usually divided into multiple data sets. In particular, three data sets are commonly used in various stages of the creation of the model: training, validation, and test sets. The model is initially fitted on a “training data set” which is a set of examples used to fit the parameters of the model. The model is trained on the training data set using a supervised learning method. The model is run with the training data set and produces a result, which is then compared with a target, for each input vector in the training data set. An example input vector is a feature vector. Based at least on the result of the comparison and the specific learning algorithm being used, the parameters of the model are adjusted. The model fitting is able to include both variable selection and parameter estimation.

Successively, the fitted model is used to predict the responses for the observations in a second data set called the “validation data set.” The validation data set provides an unbiased evaluation of a model fit on the training data set while tuning the model's hyperparameters. Finally, the “test data set” is a data set used to provide an unbiased evaluation of a final model fit on the training data set.

“Ensemble learning” is the process by which multiple models, such as classifiers or experts, are strategically generated and combined to solve a particular computational intelligence problem. Ensemble learning is primarily used to improve the (classification, prediction, function approximation, etc.) performance of a model, or reduce the likelihood of an unfortunate selection of a poor one. In an example, an ML model selected for correlating construction data feeds is different from an ML model required for processing a statistical input for sensitivity.

FIG. 1 illustrates an example network computing system for managing AEC projects using AI mesh-based intelligent structural fabric units, according to some embodiments. FIG. 1 is shown in simplified, schematic format for purposes of illustrating a clear example and other embodiments are able to include more, fewer, or different elements. FIG. 1 and the other drawing figures, and all of the description and claims in this disclosure are intended to present, disclose, and claim a technical system and technical methods.

The technical system and methods as disclosed include specially programmed computers, using a special-purpose distributed computer system design and instructions that are programmed to execute the functions that are described. These functions are executed to provide a practical application of computing technology to the technical problem of using static and reusable sets of activities corresponding to pre-defined construction recipe templates for managing AEC projects. The current disclosure presents a technical solution to the technical problem, and any interpretation of the disclosure or claims to cover any judicial exception to patent eligibility, such as an abstract idea, mental process, method of organizing human activity, or mathematical algorithm, has no support in this disclosure and is erroneous. In some embodiments, the example network computing system 100 is able to be an AI system and includes a server computing device 102, a client computing device 104, disparate data sources 106, and an intelligent warehouse 108, which are directly or indirectly communicatively coupled with one another via a communication network 110.

In some embodiments, the server computing device 102 broadly represents one or more computers, such as one or more desktop computers, server computers, a server farm, a cloud computing platform, a parallel computer, virtual computing instances in public or private datacenters, and/or instances of a server-based application. The server computing device 102 may be accessible over the communication network 110 by the client computing device 104 to request a schedule or a resource recommendation.

The server computing device 102 is able to include one or more computer programs or sequences of program instructions in an organization. Such organization implements artificial intelligence/machine learning algorithms to generate data pertaining to various requirements, such as design consideration factors in an AEC project, controlling functions, notifying functions, monitoring functions, and modifying functions. In particular, such an organization may implement machine intelligence, smart knowledge assembly, AI, ML, and cognitive systems and methods for managing AEC projects using AI mesh-based intelligent structural fabric units. In some embodiments, one or more components of the server computing device 102 are able to include a processor configured to execute instructions stored in a non-transitory computer readable medium.

The client computing device 104 may include a desktop computer, laptop computer, tablet computer, smartphone, or any other type of computing device that allows access to the server computing device 102. The elements in FIG. 1 are intended to represent one workable embodiment but are not intended to constrain or limit the number of elements that could be used in other embodiments.

In some embodiments, a set of diverse or even mutually exclusive programs or sequences of instructions are organized together to implement diverse functions to generate data associated with design consideration factors. Such a set may be referred to herein as a model ensemble 112 to implement an ensemble learning. Programs or sequences of instructions organized to implement the controlling functions are able to be referred to herein as a controller 114. Programs or sequences of instructions organized to implement the notifying functions are able to be referred to herein as a notifier 116. Programs or sequences of instructions organized to implement the monitoring functions are able to be referred to herein as an efficiency analysis and process monitor 118 (referred to as “monitor 118” herein). Programs or sequences of instructions organized to implement the modifying functions are able to be referred to herein as a modifier 120.

In some embodiments, the model ensemble 112, the controller 114, the notifier 116, the monitor 118, and the modifier 120 are able to be integrated together as a system on chip or as separate processors/controllers/registers. Accordingly, the respective functions of the model ensemble 112, controller 114, the notifier 116, the monitor 118, and the modifier 120 essentially correspond to processing or controller functions. In some embodiments, the model ensemble 112, the controller 114, the notifier 116, the monitor 118, and/or the modifier 120 are able to be part of an AI system implemented by the server computing device 102. In some embodiments, in keeping with sound software engineering principles of modularity and separation of function, the model ensemble 112, the controller 114, the notifier 116, the monitor 118, and the modifier 120 are each implemented as a logically separate program, process, or library. The model ensemble 112, the controller 114, the notifier 116, the monitor 118, and the modifier 120 are also able to be implemented as hardware modules or a combination of both hardware and software modules without limitation.

In some embodiments, the model ensemble 112 is able to include a plurality of modules, and each of the plurality of modules is able to include an ensemble of one or more AI models (e.g., Language Model, Transformer Model, Multilayer Perceptron, Lucas-Kanade, Adaptive Image Thresholding, Graph Cut Optimization, Support Vector Machines, Bayesian learning, K-Nearest Neighbor, Decision Graph) to process a corresponding data feed. The data feed in turn corresponds to current data received in real-time from data sources such as a local or remote database as corresponding to the knowledge database 122. Each module, which is a combination of plurality of ML modules, is programmed to receive a corresponding data feed from the knowledge database 122. Based on pertinent segments or attributes of the data feed mapping with a function objective(s), a respective module determines or shortlists an intermediary data set. For example, the intermediary data set is able to include, but is not limited to, a semantic interpretation of accrued and incoming data, a dynamic data ontology, weighted relationship amongst data segments, formulation of knowledge graph intermediate vertices and edges and that includes influencing factors in an AEC project. Further, the data feed is defined by a data structure comprising a header that includes metadata or tags at an initial section or a header of the data feed, such that the metadata or tags identify segments and corresponding data types. Alternatively, in absence of header, the metadata or tags are able to be mixed with payload in the data feed. For example, each data segment of the data feed is able to include metadata indicating a data type that the data segment pertains to. If the data type corresponds with the function objective of the respective module, then the respective module will process that data segment. The intermediary data sets are then able to be used by the controller 114 to execute one or more actions based on user inputs and/or objectives.

In some embodiments, the model ensemble 112 is able to include multiple models, such as classifiers or experts, strategically generated and combined to solve a particular computational intelligence problem. Ensemble learning is primarily used to improve the (classification, prediction, function approximation, and the like) performance of a model, or reduce the likelihood of an unfortunate selection of a poor one. In an example, an ML model selected for gathering a user intent from an input is different from an ML model required for processing a statistical input for sensitivity. The model ensemble 112 is able to include machine learning techniques, deep learning techniques, neural networks, deep learning with hidden layers, or a combination of these techniques. In some embodiments, the model ensemble 112 is able to apply a plurality of ensembles of machine learning models, as described above, to each of the plurality of data feeds to generate a plurality of intelligent knowledge units based on the user request. Each of the plurality of ensembles of the machine learning models is trained using data related to the AEC project.

In some embodiments, the notifier 116 is able to be programmed to provide notifications to the user. The notifier 116 is able to receive such notifications from the controller 114 and the intelligent warehouse 108. The notifications are able to include, but are not limited to, audio, visual, or textual notifications in the form of indications or prompts. The notifications are able to be indicated in a user interface (e.g., a graphical user interface) to the user. In one example, the notifications are able to include, but not limited to, recommendations and/or alerts associated with fitting within the bounds of project objective and evaluated for maximized returns within that set objective. In other example, a notification allows an avatar or personified animation of the user to navigate the virtual environment for visual introspection through a virtual reality headgear worn over the head and/or a stylus pen held in hand as known in the state of the art. Based on a head or limb movement of the user wearing the virtual reality headgear, the avatar is able to walk-through or drive-through various virtual locations of the metaverse. In other example, a notification facilitates such avatar to make real-time changes, updates, or annotations that affect the project objective.

In some embodiments, the monitor 118 is programmed to receive feedback that is able to be used to execute corrections and alterations at the controller 114 side to fine tune decision making. For example, the monitor 118 is able to be programmed to receive data feeds from one or more external sources, such as the disparate data sources 106.

In some embodiments, the modifier 120 is able to be programmed to receive modification data to update existing artificial intelligence models in the network computing system 100 and to add new artificial intelligence models to the network computing system 100. Modification data is able to be provided as input by the user via an input interface (e.g., a graphical user interface). In other example, the modification is able to be determined automatically through external sources and/or databases.

Computer executable instructions described herein are able to be in machine executable code in the instruction set of a Central Processing Unit (CPU) and are able to be compiled based upon source code written in Python, JAVA, C, C++, OBJECTIVE-C, or any other human-readable programming language or environment, alone or in combination with scripts in JAVASCRIPT, other scripting languages, and other programming source text. In some embodiments, the programmed instructions are also able to represent one or more files or projects of source code that are digitally stored in a mass storage device such as non-volatile Random Access Memory (RAM) or disk storage, in the system of FIG. 1 or a separate repository system, which when compiled or interpreted cause generation of executable instructions that in turn upon execution cause the computer to perform the functions or operations that are described herein with reference to those instructions. In other words, the figure represents the manner in which programmers or software developers organize and arrange source code for later compilation into an executable, or interpretation into bytecode or the equivalent, for execution by the server computing device 102.

In some embodiments, the server computing device 102 broadly represents one or more computers, such as one or more desktop computers, a server farm, a cloud computing platform (like Amazon EC2, Google Cloud, container orchestration (Kubernetes, Docker, and the like), or a parallel computer, virtual computing instances in public or private datacenters, and/or instances of a server-based application. The server computing device 102 is able to be coupled to various other resources, such as the client computing device 104, the disparate data sources 106, and the intelligent warehouse 108, via the communication network 110.

The disparate data sources 106 are able to correspond to a plurality of different resources that are disparate and seemingly unrelated to one another. Data/knowledge sourced from such disparate data sources 106 is both domain specific as well as correlational knowledge. Such sourced data/knowledge is able to correspond to different types or formats residing in separate systems, databases, or file formats, and that are not necessarily designed to be integrated or compatible with each other. In some embodiments, the controller 114 in the server computing device 102 is able to conduct a combinatorial analysis of the data/knowledge provided by such disparate data sources 106 by applying a plurality of ensembles of machine learning models to each of the plurality of data sources, for example identify relationships between various data feeds and then channelize the learnings to form correlation and/or linkages between data. The controller 114 is able to build relationships within the data sets and/or data feeds that may appear unrelated, and utilize computational, mathematical, and statistical models and machine learning algorithms to correlate the seemingly unrelated data.

The intelligent warehouse 108 is able to include additional databases storing data that is able to be used by the server computing device 102. Each database is able to be implemented using memory, e.g., RAM, EEPROM, flash memory, hard disk drives, optical disc drives, solid state memory, or any type of memory suitable for database storage. The intelligent warehouse 108 is able to include various databases, such as a knowledge database 122, a project objectives database 124, a model configuration database 126, a training database 128, a recommendation database 130, an intent analytical segments database 132, an image generator database 134, and a real-time feed interface 136.

In some embodiments, the knowledge database 122 is able to store a plurality of data feeds collected from various disparate data sources 106, such as a construction site or an AEC site, third-party paid or commercial databases, and real-time feeds, such as Really Simple Syndication (RSS), or the like. The plurality of data feeds may be categorized as corresponding to facts, rules, attributes, objects, definitions, events, processes, heuristics, hypothesis, and relationships. A data feed is able to include data segments pertaining to real-time climate and forecasted weather data, structural analysis data, in-progress and post-construction data, such as modular analysis of quality data, inventory utilization and forecast data, regulatory data, global event impact data, supply chain analysis data, equipment and IoT metric analysis data, labor/efficiency data, and/or other data that are provided to the modules of the modules of the model ensemble 112 in line with respective project objective(s). Each data segment is able to include metadata indicating a data type of that data segment. As described herein, the real-time data, near real-time data, and collated data are received by the monitor 118 and are processed by various components of the server computing device 102 depending on the user intent and project objectives.

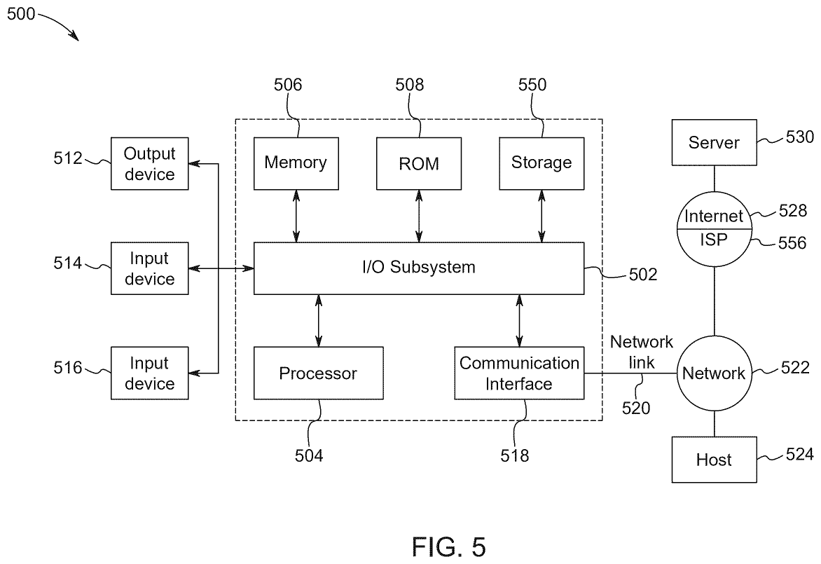

In some embodiments, the knowledge database 122 may be implemented by deploying various memory modules in the non-transitory computer-readable storage media accessible to one or more processors of a computer system, as described in FIG. 5. The one or more processors may determine events and statistical correlations between disparate data feeds and store them in the knowledge database 122. Such memory modules may include implicit memory (such as procedural memory) and declarative memory. The declarative memory may further include episodic memory (such as events, times, places, and autobiographical details (i.e., who, what, how, and why)) and semantic memory that is based on factual information. Such memory modules may be realized by the different memory devices, as described in FIG. 5.

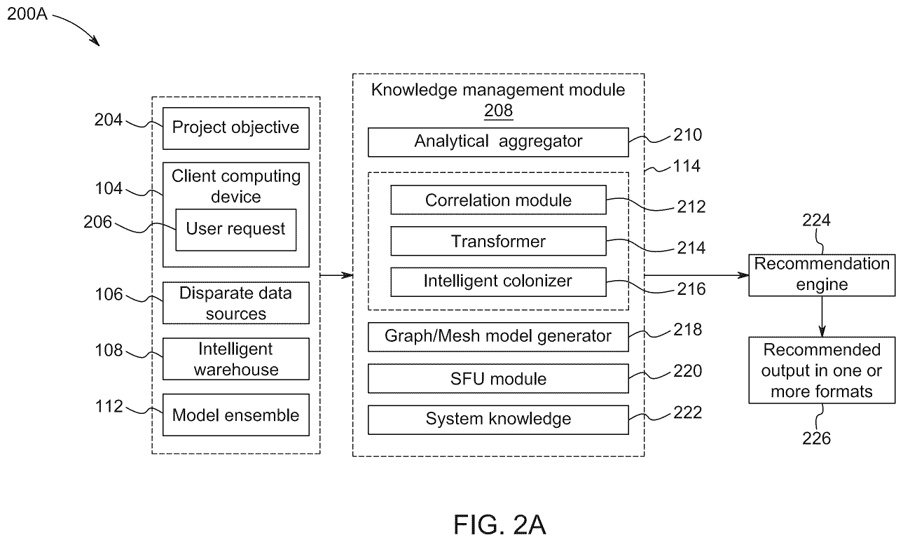

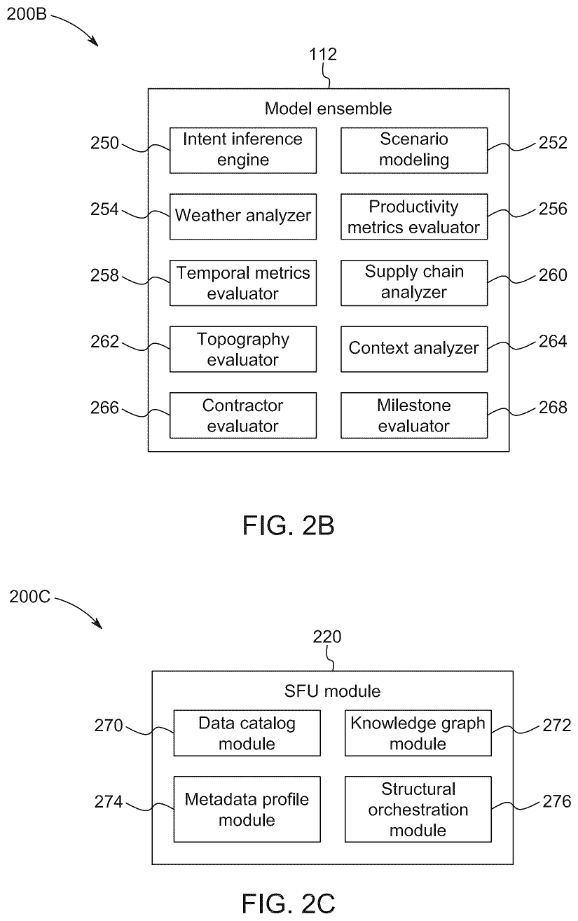

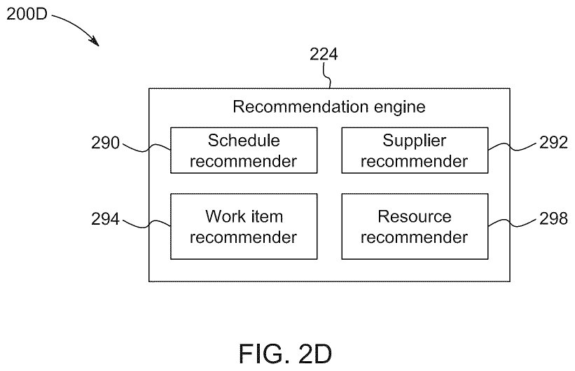

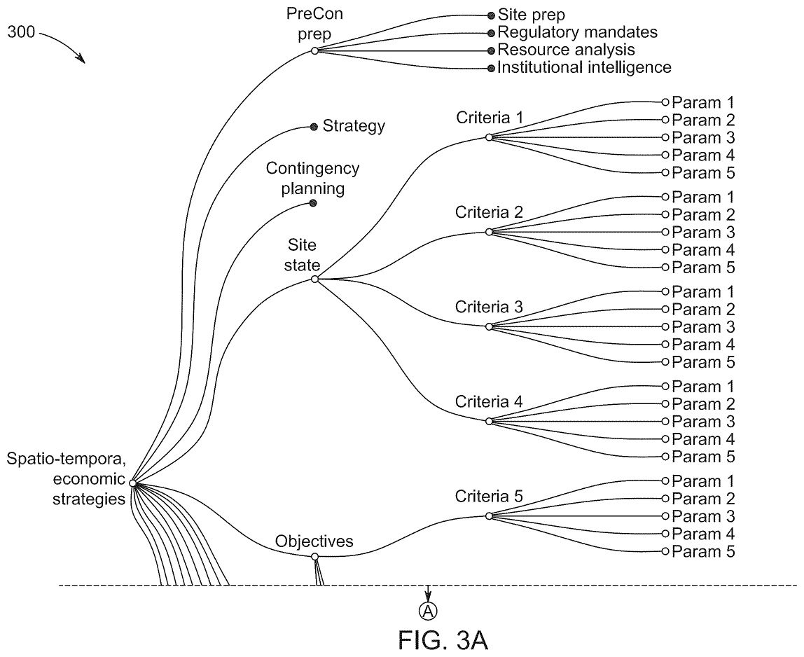

In some embodiments, the project objectives database 124 is able to include a plurality of project objectives, such as project objective 204 described in FIG. 2A. Each of the plurality of data feeds in the knowledge database 122 is processed to achieve one or more of the plurality of project objectives in the project objectives database 124. The project objectives, as exemplified in the forthcoming description, are a collection of different user requirements, project requirements, regulatory requirements, technical requirements, and the like, related to an AEC project.

In some embodiments, the model configuration database 126 is able to include configuration data, such as parameters, gradients, weights, biases, and/or other properties, that are required to run the artificial intelligence models after the artificial intelligence models are trained.

In some embodiments, the training database 128 is able to include training data for training one or more artificial intelligence models of the network computing system 100. The training database 128 is continuously updated with additional training data obtained within the network computing system 100 and/or external sources. Training data includes historical data, factual data, and human cognitive factors associated with a user and various construction elements. Human cognitive factors indicate how does a human expert devoid of emotional variables decide and act in certain situations, such as, interpreting a given situation, a given constraint, a given element or in dealing with a sub-optimal situation leading to a schedule or cost impediment. For example, in a given situation along the course of an AEC project, how would a site supervisor decide if a given set of tasks run into effort overruns.

Training data includes historic customer data and synthetically algorithm-generated data tailored to test efficiencies of the different artificial intelligence models described herein. Synthetic data is able to be authored to test a number of system efficiency coefficients. The system efficiency coefficients are able to include false positive and negative recommendation rates, model resiliency, and model recommendation accuracy metrics.

In some embodiments, the recommendation database 130 includes recommendation data, such as recommended actions associated with the AEC project. The intent analytical segments database 132 is able to parse, identify, store, and analyze analytical portions of user inputs related to an intent of a user. The image generator database 134 is able to convert non-graphic data feeds to graphic and/or images for further analysis and/or depiction. Further, the real-time feed interface 136 is able to provide real-time data, such as a live camera feed, to the intelligent warehouse 108.

The communication network 110 broadly represents a combination of one or more LANs, WANs, metropolitan area networks (MANs), global interconnected internetworks, such as the public internet, or a combination thereof. Each such network is able to use or execute stored programs that implement internetworking protocols according to standards such as the Open Systems Interconnect (OSI) multi-layer networking model, including but not limited to, Transmission Control Protocol (TCP) or User Datagram Protocol (UDP), Internet Protocol (IP), Hypertext Transfer Protocol (HTTP), and so forth. All computers described herein are able to be configured to connect to the communication network 110 and the disclosure presumes that all elements of FIG. 1 are communicatively coupled via the communication network 110. The various elements depicted in FIG. 1 are also able to communicate with each other via direct communication links that are not depicted in FIG. 1 to simplify the explanation.

The ML models disclosed herein are able to include appropriate classifiers and ML methodologies. Some of the ML algorithms include (1) Multilayer Perceptron, Support Vector Machines, Bayesian learning, K-Nearest Neighbor, or Naïve Bayes as part of supervised learning, (2) Generative Adversarial Networks as part of Semi Supervised learning, (3) Unsupervised learning utilizing Autoencoders, Gaussian Mixture and K-means clustering, and (4) Reinforcement learning (e.g., using a 0-learning algorithm, using temporal difference learning), and other suitable learning styles. Knowledge transfer is applied, and, for small footprint devices, Binarization and Quantization of models is performed for resource optimization for ML models. Each module of the plurality of AI models is able to implement one or more of: a Language Model, regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, iterative dichotomiser 3, C4.5, chi-squared automatic interaction detection, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, a linear discriminate analysis, and the like), a clustering method (e.g., k-means clustering, expectation maximization, and the like), an associated rule learning algorithm (e.g., an Eclat algorithm, and the like), an artificial neural network model (e.g., a Perceptron method, a back-propagation method, a self-organizing map method, a learning vector quantization method, and the like), a deep learning algorithm (e.g., a restricted Boltzmann machine, a deep belief network method, a convolution network method, a stacked auto-encoder method, and the like), and a dimensionality reduction method (e.g., principal component analysis, partial least squares regression, multidimensional scaling, and the like). Each processing portion of the network computing system 100 is additionally able to leverage: a probabilistic, heuristic, deterministic or other suitable methodologies for computational guidance, recommendations, machine learning or combination thereof. However, any suitable machine learning approach is able to otherwise be incorporated in the network computing system 100. Further, any suitable model (e.g., machine learning, non-machine learning, and the like) is able to be used in the network computing system 100 of the present disclosure.

FIG. 2A illustrates an example computational system for managing AEC projects using AI mesh-based intelligent structural fabric units, according to some embodiments. FIG. 2B illustrates an example computational system 200B for the model ensemble 112, in accordance with the disclosed embodiments. FIG. 2C illustrates an example computational system for an intelligent structural fabric unit (SFU), in accordance with the disclosed embodiments. FIG. 2D illustrates an example computational system 200D for the recommendation engine 224, in accordance with the disclosed embodiments. FIGS. 2A to 2D are described in conjunction with each other.

Referring to FIG. 2A, the computational system 200A includes a plurality of input parameters, such as project objective 204 and user request 206. The plurality of input parameters may also include the disparate data sources 106, the intelligent warehouse 108, and the model ensemble 112, as already described in FIG. 1. The computational system 200 may further comprise a knowledge management module 208 that may further comprise an analytical aggregator 210, a correlation module 212 (further comprising a transformer 214 and an intelligent colonizer 216), a graph/mesh model generator 218, an SFU module 220, and system knowledge 222. The computational system 200 may further comprise a recommendation engine 224 configured to generate recommended output in one or more formats 226.

The project objective 204 may be established prior to the start of construction activities and are able to be adjusted during construction phases to factor in varying conditions. The project objective 204 may be defined at each AEC project and construction phase level. Data definition of the project objective 204 defines normalized project objectives. Examples of such normalized objectives include parameters for optimization of construction schedule to meet time objectives, optimization for cost objectives, optimization for carbon footprint objectives, which are normalized to factor in worker health, minimization of onsite workers, and minimization of quality issues. Further, the project objective 204 are able to be identified as part of a user input, such as in form of the user request 206 for a construction activity of an AEC project.

In one example, the project objective 204 is able to be to keep the cost below a budgeted amount. The monitor 118 is able to receive data feeds corresponding to cost analysis from external sources and store the data feeds in the knowledge database 122. The controller 114 is able to receive the data feeds from the knowledge database 122, or alternatively, receive the data feeds from the monitor 118, and then check the received data feeds against the established objectives (e.g., a set benchmark or threshold) to be in alignment for set project objectives stored in the project objectives repository, i.e., the project objectives database 124. While the set benchmark corresponds to a predefined metric, the set objective corresponds to an objective created in real time based on the user input. For example, if the incoming data feeds indicate that construction completion date may exceed a deadline, then the controller 114 is able to explore one or more solutions to expedite. In this context, the controller 114 is able to determine that reshuffling of tasks, adding additional construction workers, and procuring materials from a nearby supplier even at the cost of higher expenditure than proposed budget is expected to minimize shipping time and eventually help in meeting the proposed deadline associated with the completion date. However, since the desired objective is also to keep the cost below or at the allotted budget level, system recommendation from the controller 114 might also resort to overlook expediency and instead maintain work at the current pace with the current mandates. Such system recommendation to ignore expediency and persist with the current pace and resources is expected to have checked the project objectives database 124 as well as any other legal commitments, before giving up the options to expedite and persist with current pace. In a different example scenario, if the project objective 204 is to honor the set construction completion date at the cost of preset budget, then the system recommendation is able to override the current pace of work and instead enforce its explored recommendations to expedite, e.g., adding additional construction workers, procuring material from a nearby supplier among other considerations.

The user request 206 may correspond to an input provided by the user at the client computing device 104 via a user interface. The user request 206 may identify a request for a schedule or a resource recommendation. The user request 206, upon further analysis and contextualization by one or more processors, may infer an intent of the user. For example, for a user request “Window panel is to be installed in next two days,” the inferred intent may be that the pane installation activity is time intensive, irrespective of the cost and labor requirements. In some embodiments, the user request 206 may include feedback that may be used to execute corrections and alterations at the controller 114 side to fine tune decision making.

The model ensemble 112 may receive input data from the data repositories in the network computing system 100. For example, the model ensemble 112 may receive one or more data feeds from the knowledge database 122 and/or the disparate data sources 106. Accordingly, the model ensemble 112 may predict or otherwise generate intermediary data set(s), for each data feed, that may be further processed by the controller 114. Referring to FIG. 2B, the model ensemble 112 may include various submodules, such as an intent inference engine 250, a scenario modelling 252, a weather analyzer 254, a productivity metrics evaluator 256, a temporal metrics evaluator 258, a supply chain analyzer 260, a topography evaluator 262, a context analyzer 264, a contract evaluator 266, and a milestone evaluator 268. One or more of these submodules may be implemented using software, hardware, firmware, or a combination thereof. In some embodiments, one or more submodules may implement and use AI, ML, and cognitive methods for implementation of their associated functionalities. One or more processors may perform the methods described in accordance with the embodiments of the present disclosure. The processor may be programmed into the integrated circuits of the processor, or loaded in memory, storage device, or network, or combinations thereof.

The intent inference engine 250 is able to receive a user input, such as from the client computing device 104, and generate intent inferences from the received user input. In some embodiments, intent inferences are generated from the received user input using one or more machine intelligence, smart knowledge assembly, AI, ML, and/or cognitive methodologies. In some embodiments, intent inferences are achieved through application of one or more logical rules to the user input to evaluate and analyze new information. For example, a logical rule that is inferred and machine composed is able to beIf the phase of an AEC project is an initial preconstruction phase and the user is asking the example computational system 200A a question—“Update me on the Project”, the example computational system 200A understands the user intent as a general update on permits, land preparation and allotted budget. However, if during the construction phase, the AEC project is facing delays and overruns, and the user asks the same question to the example computational system 200A, at this time, the example computational system 200A understands the criticality of the situation, and the intent is to find solutions to unblock the impediments. Based on the notion, the example computational system 200A is able to state the impediments and resolutions and not go into a verbose articulation of the project updates. This is able to be referred to as situational intelligence. The logical rules composed in such an example case are able to beFactor in phase, criticality, schedule, and cost impact at a given time and use that to compose appropriate intelligent knowledge units to respond to a user input.

In some embodiments, the intent inference engine 250 is able to be configured to process ecosystem data in an AEC environment related to an AEC project. In various examples, the intent inference engine 250 is able to parse the design and design composites to infer the intent of a user, interpret the schedule intent and expectations with respect to time and cost, infer the design nuances and the intent due to the relationship with space and geometry parameters, and the like.

The scenario modelling 252 may play and/or validate multiple scenarios associated with the AEC project and/or the user request 206. In some embodiments, the scenario modelling 252 is a part of the model ensemble 112. Scenario modelling 252 runs an exemplary scenario and provides a corresponding output to the correlation module 212.

In some embodiments, scenario modelling 252 may vary one or more parameters associated with AEC project and/or the user request 206 to run different scenarios. An exemplary scenario may include, for example, an impact on labor, cost, time, material, and schedule due to issues, such as quality issues, are taken into consideration for optimizing the schedule. Another exemplary scenario may include, for example, an analytical user interacting with an analytic warehouse, setting up scenario templates to support business user simulation, and setting up reports. Yet another exemplary scenario may include, for example, a business user configuring scenarios by setting selected decision parameters, running simulations, and analyzing the reports.

In some embodiments, the scenario modelling 252 and/or the associated model ensemble 112 may run a what-if analysis, for example, what-if the schedule is delayed, what if unforeseen weather changes occur, what if the labor productivity decreases, and the like. In some embodiments, the scenario modelling 252 and/or the associated model ensemble 112 may run “what worked well” and “what can be affected” analysis. For example, learnings from various metrics associated with the construction and delivery of first 10 houses of an AEC project of 50 houses. Some of these are probabilistic computations by the scenario modelling 252 and/or the associated model ensemble and the techniques employed may include machine inference through Expectation Maximization as Dynamic factor, Directed and Non-Directed graphs, Swarm agents to look for specific patterns in the forecast, greedy algorithm, Bayes and Mark models, and the like. The system may also employ Stochastic Models to look for events that could impact the prediction and which should be factored in for scenario analysis in anticipation of the future.

In some embodiments, the output of the scenario modelling 252 may include, for example, optimal values of tunable decision parameters, based on the combination of parameters analyzed by the scenario modelling 252 as part of the exemplary scenario. Similarly, multiple other scenarios may be run and/or played by the scenario modelling 252 and corresponding outputs may be provided to the correlation module 212 for further analysis and processing.

The weather analyzer 254 may receive one or more input data sets for analysis of localized historical weather patterns, microclimate analysis, forecasted weather analytics, stochastic modeling of events, correlation to supply storage, supply availability, shipping, correlation to working conditions, correlation to materials and material behavior (e.g., curing of weatherized cement), and analysis of drainage, wind, sand, and the like. Machine learning models of the weather analyzer 254 may provide climate factors in real time as well as what is projected for the next several weeks, for example. The input data sets may also include historical weather/climate patterns of the locality during the construction phase of the AEC project. As discussed herein, the monitor 118 of FIG. 1 may assist the weather analyzer 254 to collect relevant input data sets. The weather analyzer 254 may dynamically receive such inputs and provide recommendations that are optimized for weather-related events.

The productivity metrics evaluator 256 may objectively evaluate the quantification of various physical quantities. In one example, the productivity metrics evaluator 256 may measure schedule performance index (SPI) of an AEC project based on the progress of the AEC project as against the original schedule. In another example, the productivity metrics evaluator 256 may measure cost performance index (CPI) of the AEC project by tracking the actual cost of the AEC project against the allocated budget. In yet another example, the productivity metrics evaluator 256 may measure labour productivity based on units of work completed per hour or day. In other examples, the productivity metrics evaluator 256 may measure equipment productivity indicating the effectiveness of equipment usage, and material productivity for tracking the efficiency of material usage and waste reduction during the AEC project. Such productivity metrics facilitate optimized operations, reduced costs, and improved project delivery for the AEC projects.

The temporal metrics evaluator 258 may determine time-related data, based on which performance, progress, and efficiency in AEC projects may be measured and analysed. Various examples of the temporal metrics used in the construction industry may include, but not limited to, time-to-completion, project duration, earned value management (EVM), critical path method (CPM), and the like. Based on such metrics, areas of inefficiency, optimization of resource allocation, and reduced project timelines may be determined.

The supply chain analyzer 260 of the model ensemble 112 receives one or more input data sets for analysis of task maps (listing of tasks/schedules), supplier analysis, estimated procurement time, historical efficacy analysis, time to value—from ordering to delivering (e.g., cost, time, carbon considerations, and the like)—and plans procurement based on current progress and projected tasks, onsite/offsite storage factors, and the like. This may also be a factor in the global event impact analysis. The supply chain analyzer 260 may identify an optimum place to procure materials and the optimum time to procure such materials. The place and time may be optimized to meet construction objectives, for example, cost, sustainability, environmental objectives, and business objectives. As discussed herein, the monitor 118 may assist the supply chain analyzer 260 to collect relevant input data sets.

The topography evaluator 262 of the model ensemble 112 may be configured to analyze and interpret topographic data, i.e., the shape and features of a surface or landscape of a site of the AEC project. By means of various examples, the topography evaluator 262 may perform land classification, terrain analysis, and feature extraction. The topography evaluator 262 may deploy various techniques, such as topographic mapping, terrain analysis, and spatial analysis to extract meaningful insights from the topographic data, evaluating the underlying structure and relationships within the topographic data, thereby leading to better model performance and decision-making for various tasks of the AEC project. For example, for a job task, “Laying a foundation,” the topography evaluator 262 may provide insights, such as soil composition, whether the construction area gathers surface runoff, steep slopes, and the like. Similarly, for another job task, “Window panel is to be installed in next two days,” the topography evaluator 262 may provide insights, such as surface elevation, slope, and orientation of the construction site, contours of the ground, soil stability and settlement potential, vegetation and land use, and the like.

The context analyzer 264 is able to be configured to map the processed user input from the user request 206 with a context relevant to the AEC project, a current scenario, or the user input. For example, the user request 206 may include a query including phrases and semantic cues (for example, “Give me an update of the project”). The phrases and semantic cues in the one or more user queries are able to be construed based on a construction stage, phase and current work done. Accordingly, if the user request 206 is generated on day 1 of the AEC project, the system may provide details, such as project manager, team composition, start/end date, and the like. However, if the user request 206 is generated during the middle of the AEC project, the system may provide details, such as project delayed for 30 days, a set of meaningful actions, and the like. The user query is executed using one or more machine intelligence, smart knowledge assembly, AI, ML, and cognitive techniques to contextualize the intent of the user, perform an intent-based computation, and provide a more relatable, contextual, and relevant response for the user query.

The contractor evaluator 266 may be configured to evaluate construction contractors' efficiencies to make recommendations for contractor selection for a desired task based on contractor output and progression metrics, and other factors, such as cost, proximity, quality, and time. In some embodiments, when a desired contractor is paired with a set of tasks, the contractor evaluator 266 recommends an optimal path for task implementation based on ground truth computation of on-site metrics and schedule derivatives. Ground truth computation is arrived at by introspecting data inputs including observation reports, daily logs, quality analysis, visual analysis, and voice-based annotations. Example models and algorithms may leverage Latent Semantic Analysis (LSA), Correlated Topic Modeling (CTM), Named Entity Recognition (NER) and knowledge graphs. Neural networks that employ convolutions and reinforcement learning may be utilized to process image-based inferences.

The milestone evaluator 268 may be configured to determine task/work progression to predict/estimate a percentage of completion (e.g., phase 1 completed, ground flow completed, or 60% complete, etc.) based on data corresponding to structural status, work progression monitoring, and data feeds (for example, video inputs) of construction progress. For example, the milestone evaluator 268 may determine an actual status of the task based on the multiple input parameters and conclude that certain aspects of the task are incomplete or need to be reworked.

In some embodiments, the milestone evaluator 268 may deploy supervisory model evaluation configured for executing and analyzing simulated and realized scenarios and evaluating different data and model features. Feature weights may be dimensionally varied to support the model execution. One model may highlight a desired efficacy outcome and use simulation to feed the decision graph in coming up with multiple paths (schedule and tasks) to achieve the outcome. Discriminant analysis feeds off predictions factoring in current scenarios. Different feature weights factor in, for example, seasonality, workers onsite, worker injury simulation, quality issues, supply constraints among others.

Referring back to FIG. 2A, the knowledge management module 208 that may be configured to generate knowledge graph assemblies and intelligent structural fabric units based on inputs received from the project objective 204, the user request 206, the disparate data sources 106, the intelligent warehouse 108, and the model ensemble 112.

The analytical aggregator 210 in the knowledge management module 208 may analyze information, such as the intermediary data sets from the model ensemble 112, to determine a subset of data from the intermediary data sets that are relevant to the project objective 204 and the construction activity. In some embodiments, the analytical aggregator 210 may perform correlations of the data subset and the current construction scenario (e.g., ground truth), using various techniques, such as self-learning multi factor predictive and stochastic analysis. In some embodiments, the analytical aggregator 210 may determine what data is relevant (from the intermediary data sets) to the project objective 204 and uses the correlation module 212 to correlate various outputs of the machine learning models (e.g., data subset determined to be relevant and output by the analytical aggregator 210) to the current construction scenario.

The correlation module 212 may conduct a combinatorial analysis of the various data feeds obtained from the plurality of data sources by applying a plurality of ensembles of machine learning models to each data feed. For example, the correlation module 212 may identify relationships between various data feeds and then channelize the learnings to form correlation and/or linkages between data. That is, the correlation module 212 may build relationships within the data sets and/or data feeds that may appear unrelated, and utilize computational, mathematical, and statistical models and machine learning algorithms to correlate the seemingly unrelated data. For example, the correlation module 212 may receive multiple scenario outcomes from a scenario modelling 252 (as described in FIG. 2B) and may correlate these to the data from the project objective 204, and other parameters, such as, but not limited to, location information, nature of land and surroundings, relatable patterns from comparable topography, and more. Each of these metrics is given a specific score and analyzed individually and in combination with other data. The correlation module 212 may then analyze the relevance of each of the data metrics and may correlate these to determine the influence of each of the data metrics on moving closer towards the given project objective. The correlation module 212 and/or the associated model ensemble may use modeling techniques such as, but not limited to, semantic network, transformer models, sentence embeddings using Siamese BERT-Networks, Neural Networks, statistical correlations, trend prediction, Clustering techniques, decision trees, decision forest, nearest neighbor computation, and the like. Since the ensemble uses multiple models, each incentivized to get closer to the set objective, different models may employ one or more of the above algorithmic techniques to achieve the objective. The correlation module 212 may take the output of each model's computation and may evaluate the combined result to generate an output.

The transformer 214, in combination with the intelligent colonizer 216, may be employed by the correlation module 212 to correlate input data, i.e., the plurality of data feeds. The correlation module 212 may further perform introspected analysis of input data. It may employ several different computational algorithms/models, as described above. Some of the algorithms/models may include, but are not limited to, an artificial neural network model (e.g., a Perceptron method, a back-propagation method, a self-organizing map method, a learning vector quantization method, etc.), a deep learning algorithm (e.g., a restricted Boltzmann machine, a deep belief network method, a convolution network method, a stacked auto-encoder method, etc.), and the like. Further, the system may determine weight associated with different data attributes, which attributes to include, which attributes to include exclude, and the like. The system may also employ genetic algorithms/models for a heuristic approach. The genetic algorithms/models may be used as a fitness function test during the computation process. The system further analyzes a set of features in a data domain to determine which of these features when sustained and/or enriched will lead to a positive outcome with respect to the set project objective 204. For example, the correlation module 212 may mute and/or negate a particular feature to determine what the outcome is. Thus, weights associated with the features may be computed in isolation using several computational techniques/model, such as, regressive models, decision trees and/or decision graphs, decision mining, and the like. Once the system determines which features and/or factors are playing a major role associated with the project objective 204 in an area, the system may employ colonizer analysis to determine optimal path to the end objective. Colonizer analysis conducted by the intelligent colonizer 216.

The intelligent colonizer 216 may include multiple Artificial Intelligent (AI) Colonizer and captive agents. The term “AI colonizer” or “colonizer” as used herein may refer to a smart entity that performs an action or generates relevant information in order to accomplish a goal and/or a task. The colonizer may be a computer program or a module or a system that is designed to process information, perceive its environment, make intelligent decisions, and take one or more actions to achieve a specific task. Further, the colonizer may influence, incentivize, and exercise control or governance over other agents, referred to as “captive agents” or “agents”. For example, the AI colonizer could direct the actions of captive agents, possibly limiting their autonomy by prescribing specific tasks or roles without allowing deviation from predetermined objectives. In a scenario involving multiple AI colonies, an AI colonizer might control resources, such as computational power, data access, or energy sources and allocate these in a manner that prioritizes its objectives. The colonizer may make decisions on behalf of or that significantly affect the captive agents. The AI colonizer may monitor captive agents' activities to ensure compliance with the colonizer's directives and to gather data for optimizing control strategies.

For example, a first colonizer may be tasked with a task associated with evaluation of productivity metrics, a second colonizer may be tasked with a task associated with evaluation of anticipated weather phenomena, a third colonizer tasked with a task associated with topography evaluation, a fourth colonizer may be tasked with a task associated with historical context on what worked well and what to avoid, a fifth colonizer may be tasked with a task associated with supplier evaluation, a sixth colonizer may be associated with tasked with a task associated with contractor evaluation, a seventh colonizer may be associated with tasked with a task associated with milestone evaluation, and an eighth colonizer may be associated with tasked with a task associated with other influences. These tasks may be associated with project objective 204 directly or indirectly. In some embodiments, these tasks may include data attributes or feature weightage analysis. Each captive agent may also simultaneously be moving towards the project objective 204.

The colonizers and captive AI Agents, as described above, may work individually or collectively in a group or a “colony” of agents to generate intermediary output. The term “colony” as used herein may refer to a decentralized and self-organized network or system comprising of multiple AI colonizer, peer captains, and captive agents interacting with one another and with the environment. As described above, each colonizer, peer captain, and captive agent may be associated with a task or a goal.

In some embodiments, instead of one AI entity and/or model working to complete the task, the intelligent colonizer 216 includes a colony of colonizers and agents working towards the common goal. For example, a colony of AI colonizers and agents, including, at least the first colonizer, and a first set of agents may be working towards a goal. As the AI colonizers and agents work towards meeting the goal, not all AI agents actively move towards the goal. They work collectively, efficiently, and intelligently in meeting the end objective. In some embodiments, the first colonizer may have moved closer to the goal, while one agent may be moving in a different direction exploring other attributes and/or paths. Meanwhile, the first set of AI agents may be waiting for other AI Agents to progress. The first colonizer may identify a set of data attributes or relevant features and generate a positive reinforcement metrics based on its movement towards the goal in order to incentivize and influence the first set of agents to follow the path led by the first colonizer. The agents may subscribe to the first colonizer and follow the path incentivized by the first colonizer. The first set of agents are referred to as captive agents of the first colonizer. The one agent may decide to unsubscribe to the first colonizer and follow a different path, other than the one incentivized by the first colonizer.

In the example, the positive reinforcement metrics may include a numeric and/or inferential score calculated by objective evaluation of each AI colonizer and agent's performance with respect to the set objective. For example, if the goal is to change the placement of the window panel on the wall, each AI Colonizer and Agent may run AI analysis, using one or more AI models, on different parameters that play a part in determining the optimal placement of the window panel. An AI Agent may analyze the productivity metrics in terms of SPI, CPI and labor productivity, the AI Agent may award itself a data point. Similarly, the AI Agent will play different scenarios based on multiple different placements, and each time the goal is met, a data point is awarded to the AI Agent. All AI colonizers and agents will conduct a similar analysis to meet the set objective and/or goal. Finally, a numeric score may be calculated for each AI colonizer and agent based on the rewarded data points. In some embodiments, it may be a numeric score, that is, a sum of the data points, for example. In other embodiments, it may be an inferential score based on the analysis of how close the AI colonizer or the agent was in meeting the set objective and/or goal. These scores may be used by the AI colonizer as the positive reinforcement metrics for influencing other agents to be its captive agents. The first set of agents may analyze the positive reinforcement metrics and explore the intent behind the path of the first colonizers and may subscribe to the first colonizer accordingly. For example, the AI agents not only analyze the numeric and/or inferential score of the colonizer but also look at how the score was achieved. That is, the intent behind the path set by the colonizer is analyzed by analyzing which data attributes and/or parameters were considered and varied by the colonizer and what could be the associated causality of that metric.

In some embodiments, each colony of colonizers and captive agents works with other colonies collectively to meet the project objective 204. The first colonizer and the first set of agents may be working collectively in a decentralized and self-organized network to meet the first goal. A second colonizer and a second set of agents may be working collectively in a decentralized and self-organized network to meet a second goal, and so on. All such goals, such as the first and the second goals, may refer to optimizing a project objective by varying weightage associated with a feature or a data attribute. Further, optimal output of such goals may be correlated, by the correlation module 212, for example, to meet and/or generate recommendation associated with the project objective 204.

In some embodiments, the multiple colonizers may act as peer captains acting in concert with or in support of each other's goals and directives. The peer captains may communicate and coordinate to synchronize their actions and share information efficiently. The peer colonizers may coordinate on resource allocation, resolving conflicts, implementing redundancy protocols, and to continually adapt the AI colonies' overall strategy based on new data and changing conditions. The multiple colonizers may generate one or more intermediary outputs associated with their irrespective goals and overall project objective 204. These intermediary outputs may then be weighted and combined to generate weighted outputs. In some embodiments, the system may assign weights to each of the one or more intermediary outputs, generate a first weighted output based on the assigned weights, determine, a difference between the first weighted output and an expected output, and adjust the assigned weights to minimize the difference between the first weighted output and an expected output. The weighted outputs are assembled by a supervisory algorithm in view of project objective 204 to generate one or more computational predictions corresponding to the project objective 204.

The graph/mesh model generator 218, based on the inputs received from the correlation module 212, uses graphical representations in the form of knowledge graph assemblies as well as social graphs to indicate weighted tasks. The knowledge and social graphs may have multiple nodes and perform specific functions and analyze data sets, such as tenant data sets including data from another activity of the AEC projection and/or data from another AEC project, to assess an impact on factors relating to the current AEC project or construction activity. For example, the graph/mesh model generator 218 may use different tenant knowledge (e.g., knowledge from other construction activities, other AEC projects) and applies this knowledge to the current construction activity. The tenant knowledge indicates, for example, are the global events really going to be impacting the schedule and if so, what is the proximity of this impact; does it impact a singular task or does it impact an entire work package, or does it impact the entire construction site, and the like. The graph/mesh model generator 218 may provide intermediary data sets including weighted tasks, as the analyzed output. Based on such intermediary data sets, intelligent structural fabric units may be generated.

In some embodiments, the knowledge graph assemblies generated by the graph/mesh model generator 218 may include a plurality of modalities and contours. The plurality of modalities may correspond to multiple variations of nature of data with respect to human cognition. The plurality of contours may correspond to multiple dimensions of data, for example, time, cost, and the like.

The SFU module 220 may correspond to a data fabric architecture that may be configured to provide semantically organized and standardized techniques to implement intelligent structural fabric units via various types of local and external endpoints and/or APIs. In other words, the SFU module 220 may implement an aggregation of data and metadata from the project objective 204, the user request 206, the disparate data sources 106, the intelligent warehouse 108, and other storage architectures associated with, for example, an organization or an enterprise. In some embodiments, the SFU module 220 may implement the intelligent structural fabric units as a data mesh. The data mesh may be configured to harmonize data implementation over multiple data repositories (for example, data lakes, data warehouse, and the like) and multiple data operation processes. In some embodiments, a data mesh-based architecture may implement specialized endpoints and APIs through which data may be integrated. In some embodiments, the SFU module 220 may be further configured to adaptively update intelligent structural fabric units to generate morphed intelligent structural fabric units based on the knowledge graph assembly.

Referring to the example computation system 200C of FIG. 2C, the SFU module 220 may include various sub-modules, such as a knowledge catalog module 270, a classification module 272, and a structural orchestration module 274.

The knowledge catalog module 270 may be configured to organize intelligent knowledge units by profiling, tagging, classifying, and mapping the intelligent knowledge units to business definitions so that the user receives the desired information. The knowledge catalog module 270 may deploy effective data catalogs at scale, span all the disparate data sources 106 that store sensitive and personal data, and are populated with the right data. The data catalogs may further include business term tags and go beyond purely technical metadata to provide suitable context required to manage the intelligent knowledge units in a privacy-aware manner. The knowledge catalog module 270 may further manage a data dictionary that may be a subset of intelligent knowledge units representing the data catalog.

The knowledge graph module 272 may be configured to access, manage, and use the knowledge graph assemblies generated by the graph/mesh model generator 218. As such, the knowledge graph assembly may be implemented as a knowledge graph-as-a-service (e.g., “KGaaS”), such as a cloud-based KGaaS. In some embodiments, the knowledge graph module 272 may interact electronically with the graph/mesh model generator 218, the disparate data sources 106, and the intelligent warehouse 108 to identify, manage, derive, and form linked concepts, entities, and semantic relationships that may describe data and metadata (e.g., layered data) associated with the knowledge graph assemblies. Further, the knowledge graph module 272 may be configured to integrate knowledge, information, and data at a relatively large scale as a graph data model, whereby the knowledge graph assemblies may include nodes representing tables, columns, dashboards, reports, business terms, users, and any other layered data, such as metadata, that describes underlying graph-based data that may, for example, be mapped to tabular data formats (e.g., rows and columns), among other things.

In some embodiments, the knowledge catalog module 270 may enable machine learning discovery techniques for systematically discovering relationships between intelligent knowledge units, automate the process of associating metadata with intelligent knowledge units for activities, such as privacy protection and data quality assessment, and establish relationships between intelligent knowledge units that might otherwise be missed.

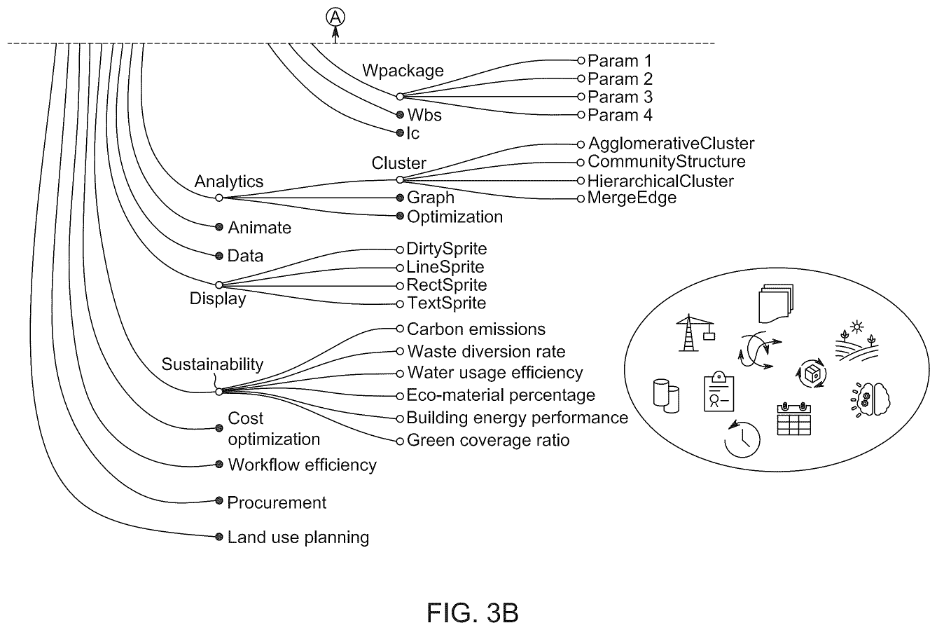

The classification module 274 may be configured to analyze, identify, classify, and implement metadata, such as attribute data, property data, and any other associated data that may be relevant or linked to any knowledge unit of data in the knowledge graph assembly. The classification module 274 may generate classifications and visual depictions of graph-based data arrangements in context of an organization and its various users. The classification module 274 may further automatically identify linked graph data to form data representing a metadata profile data file. In some embodiments, the classification module 274 and/or knowledge catalog module 270 may be configured to generate (or cause to be generated) user interface portions to generate, build, or morph (e.g., to assist predictively generated metadata) the layered knowledge in a graph-based data arrangement, as described in FIG. 3A.

The structural orchestration module 276 may be configured to generate user interface portions or programmatic executable instructions that may be configured to convey information in a summarized format. The structural orchestration module 276 may be configured to automatically implement, derive, or predict actions activated by identifying relevant subsets of executable instructions. In some examples, the structural orchestration module 276 may be configured to identify predictively relevant data regarding a portion of a knowledge graph assembly. Data representing a knowledge graph portion may include data representing one or more concept user interface portions or programmatic executable instructions. Such concept user interface portions or programmatic executable instructions facilitate discovery of relevant users, relevant resources (for example, portions of the knowledge graph assembly presented as tabular data, dashboard-based analytic and graphical data), predicted recommended actions or applications that a user may implement regarding a concept, and any other supporting information associated with the knowledge graph assembly in view of, for example, a search term or topic provided in the user request 206.

Referring back to the example computational system 200A of FIG. 2A, the system knowledge 222 in the knowledge management module 208 may be configured to apply training data, learnt or acquired knowledge and/or historical data to further process the correlated data inputs and/or streams. The system knowledge 222 may include one or more submodules configured to examine past data and trends, and to process the accessed and/or generated data to provide insights into the historical patterns related to real-world entities and/or trends. The one or more submodules, may include, but are not limited to, material types, risk patterns, resilience patterns and trends, and the like.

The recommendation engine 224 receives the processed data from the correlation module 212 and generates recommendations associated with the AEC project as the recommended output in one or more formats 226, such as reports, list of construction activities, and the like. The recommendation engine 224 may further comprise various submodules, such as a schedule recommender 290, a supplier recommender 292, a work item recommender 294, and a resource recommender 298, as described in FIG. 2C.

Referring to the example computation system 200C in FIG. 2C, the schedule recommender 290 may implement the supervisory machine learning model that generates an optimized schedule for the construction activity to meet the project objective 204 of the AEC project, based on the intelligent structural fabric units generated by the SFU module 220. In some embodiments, the schedule recommender 290 may generate, using the weighted tasks, an optimized schedule, which is output to the user by the notifier 116. The schedule may be output via a user interface, voice, messaging, and/or the like. In some embodiments, the schedule recommender 290 provides a recommendation, and the monitor 118 assesses if the recommendation was relevant and efficient in optimizing the schedule, the cost factors, and the like. The schedule recommender 290 may include a gating mechanism to evaluate its own recommendations and its own performance. For example, the schedule recommender 290 may operate in conjunction with the productivity metrics evaluator 256, the temporal metrics evaluator 258, the supply chain analyzer 260, the topography evaluator 262, the contractor evaluator 266, and the milestone evaluator 268

The supplier recommender 292 may be configured to evaluate construction suppliers' efficiencies to make recommendations for supplier selection for a desired task. In some embodiments, the supplier selection may be based on proximity, quality, cost, and the like. In an example, if incoming data feeds indicate construction completion date may exceed stated end date, then the supplier recommender 292, through smart agents, may indicate procuring materials from a nearby supplier at a higher cost to minimize shipping time can help meet the completion date.

The work item recommender 294 may be configured to reorder the sequence of some work during construction in order to minimize overall operational impacts on the AEC project which may be caused by delays or schedule changes on other AEC projects. Such changes should they occur, are anticipated to place entire blocks of work in a different order (for example work item 2 prior to work item 1) as opposed to reordering individual components of individual work areas. The supplier/contractor may be notified of any such required changes to the construction sequencing.

The resource recommender 298 may be configured to evaluate various resources, such as computational power, data access, or energy sources and recommend the allocation of these in a manner that prioritizes the project objective 204. Other resources evaluated and recommended by the resource recommender 298 may include human and material resources. For example, the resource recommender 298 may provide recommendations that adjust a task based on the efficiency metrics, wherein the efficiency metrics may be based on factoring, for example, labor issues, the pace at which the construction happens, quality issues, and the like.

FIGS. 3A and 3B illustrate a project mesh structure 300 illustrating a plurality of intelligent structural fabric units powering an AEC project, according to some embodiments. The example intelligent structural fabric units are objective-driven, self-curating, and smart entities generated by the SFU module 220 according to the phase, productivity, and AEC environment of an AEC project.

Referring to FIG. 3A, the project mesh structure 300 may include multiple enveloping structures, each enveloping structure being a composite of a set of activities. Such set of activities may be structured under an intelligent structural fabric unit. The order and time duration of such set of activities may be different. In a first scenario, during a pre-construction phase of the AEC project, for an intelligent structural fabric unit corresponding to a job task “Foundation,” a set of activities may be “1) Perform soil analysis by conducting tests to determine the soil's bearing capacity, moisture levels, and other characteristics; 2) Prepare a foundation design that accounts for load-bearing capacity, settlement, and drainage for the AEC project; 3) Select suitable materials, such as concrete or steel, for the foundation; 4) Plan the step according to weather conditions; 5) Select suitable supplier and contractor based on proximity, quality, and cost.” Such set of activities may be dynamically updated, and the intelligent structural fabric unit is adaptively morphed based on the real-time data feeds received from the disparate data sources 106.

Further, the project mesh structure 300 may include an enveloping structure that may be dynamically updated. In some embodiments, the set of activities may be updated dynamically based on decision parameters. In some embodiments, feedback received/generated at the monitor 118 may be used to tune such decision parameters and further retrain the artificial intelligence models used by the network computing system 100.

For example, in a second scenario during a building phase of the AEC project, it may be observed that the schedule is getting delayed, weather conditions are adversely affected, and the delivery is due in a fixed time period. Under such conditions, the intelligent structural fabric unit may be configured to adaptively morph itself as a dynamic artifact according to the scenario. A set of activities, and resultantly the corresponding intelligent structural fabric unit, may be adaptively morphed or updated based on an evaluation of one or more decision parameters during the construction phase and a time duration of the AEC project. The one or more decision parameters may be associated with one or more of productivity metrics, anticipated weather conditions, topography, historical context, supplier details, contractor details, and milestone details.

In some embodiments, an intelligent structural fabric unit for a construction activity may be adaptively morphed or updated using a supervisory machine learning model. For example, the schedule recommender 290 of the controller 114 may implement the supervisory machine learning model that generates an optimized schedule for the construction activity to meet the project objective 204 of the AEC project, based on the output of each of the respective modules of the model ensemble 112. In some embodiments, the output of each of the respective modules of the model ensemble 112 may be first analyzed and correlated, and then processed by to generate intelligent knowledge units for knowledge graph assemblies including weighted tasks, for the construction activity. Based on the intelligent knowledge units, a data mesh comprising adaptive structural intelligent knowledge units are generated, which in turn may recommend an optimized schedule that achieves the project objective 204.

In an embodiment as illustrated in FIGS. 3A to 3B, intelligent structural fabric unit for a construction project may incorporate a variety of spatio-tempora-economic strategies to optimize project outcomes across multiple domains. These domains may include sustainability, cost optimization, workflow efficiency, procurement, and land use planning. The intelligent structural fabric unit is able to be designed to integrate seamlessly within the broader infrastructure ecosystem, dynamically adjusting their configuration to align with evolving project demands and environmental conditions. Sustainability, in particular, may be influenced by a range of interdependent sub-factors such as carbon emissions, waste diversion rate, water usage efficiency, eco-material percentage, building energy performance, and green coverage ratio. In this embodiment, the intelligent structural fabric unit may be configured to adaptively morph in response to fluctuations in any of these sustainability indicators or in the variables upon which these indicators are based. This adaptive capability allows the intelligent structural fabric unit to support intelligent construction project management and execution.

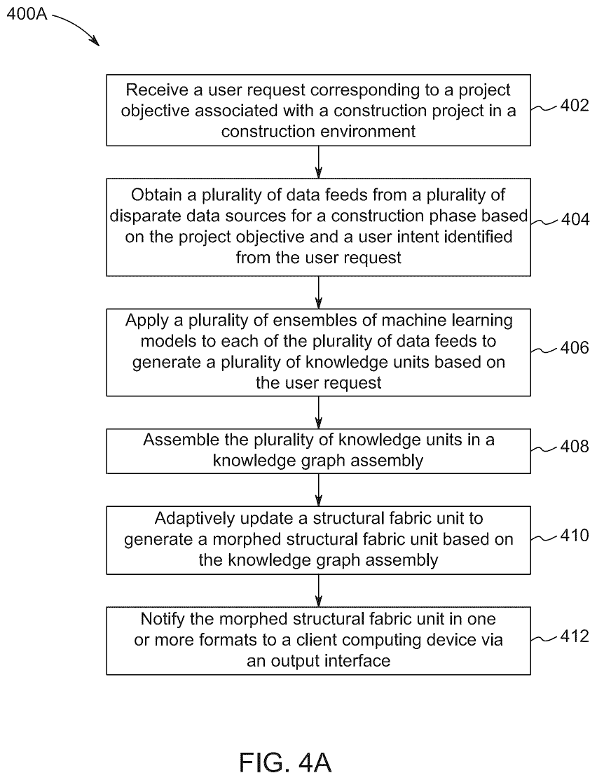

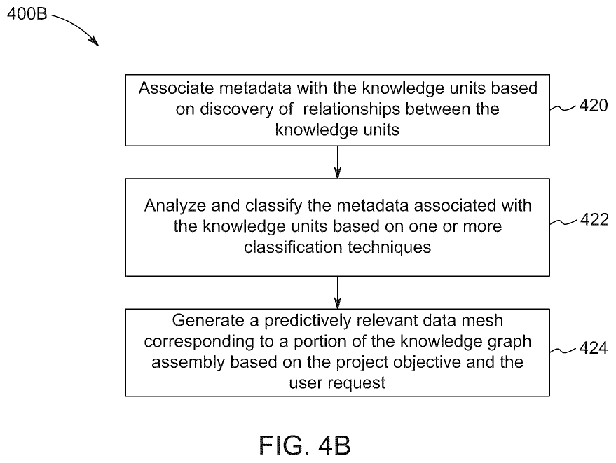

FIG. 4A illustrates a method 400A for managing AEC projects using AI mesh-based intelligent structural fabric units, in accordance with embodiments of the present disclosure. FIG. 4A will be explained in conjunction with the description of FIGS. 1 to 3B.

At step 402, the controller 114 forming a part of the server computing device 102 may receive a user request, such as the user request 206, corresponding to a project objective, such as the project objective 204, associated with an AEC project in an AEC environment. For example, the user request 206 may be “Give me a recipe to install window panels for first floor,” and “on time, on budget, meeting quality considerations” as the construction objectives (e.g., type of building, location, time frame, budget, and quality considerations).

At step 404, the controller 114 forming a part of the server computing device 102 may obtain a plurality of data feeds from a plurality of disparate data sources, such as the disparate data sources 106, for a construction phase. The plurality of data feeds may be obtained based on the project objective 204 and a user intent identified from the user request 206. In some embodiments, the monitor 118 may access the plurality data feeds from the disparate data sources 106 and store the plurality of data feeds in a data feed database (not shown). Each of the plurality of input data feeds is to be processed with the project objective 204 in consideration. Each project objective 204 may be specified or selected from a plurality of project objectives stored in the project objectives database 124.

In some embodiments, when the user intent is to “install window panels for first floor”, the intent inference engine 250 is able to generate intent inferences that recommend one or more types of panels with high energy-efficient ratings, such as low-E glass or thermal break technology, to minimize heat transfer and reduce energy bills. The intent inferences may further recommend sound-absorbing materials or features (such as, acoustic glass), weather-tight seals (to protect against rain, wind, and extreme temperatures), accessible panel styles (providing easy-open mechanisms, such as hinges or handle-free designs) and the like.

At step 406, the controller 114 forming a part of the server computing device 102 may apply a plurality of ensembles of machine learning models, such model ensemble 112, to each of the plurality of data feeds to generate a plurality of intelligent knowledge units based on the user request 206. Each of the plurality of ensembles of the machine learning models, i.e., the model ensemble 112, is trained using data related to the AEC project.

At step 408, the controller 114 forming a part of the server computing device 102 may assemble the plurality of knowledge units in a knowledge graph assembly. In some embodiments, the intelligent knowledge units may be further enriched and refined by the correlation module 212 that may identify relationships between various data feeds and then channelize the learnings to form correlation and/or linkages between the intelligent knowledge units. As shown in FIG. 2A, the correlation module 212 comprising the transformer 214 and the intelligent colonizer 216 may be configured to perform introspected analysis of the plurality of data feeds, determine weight associated with different data attributes, and analyzes a set of features in a data domain to determine which of these features when sustained and/or enriched will lead to a positive outcome with respect to the set project objective 204. For example, the correlation module 212 may mute and/or negate a particular feature to determine what the outcome is. Once the computational system 200A determines which features and/or factors are playing a major role associated with the project objective 204 in an area, the computational system 200A may employ colonizer analysis to determine optimal path to the end objective. Accordingly, the graph/mesh model generator 218 may generate a knowledge graph assembly.

At step 410, the controller 114 forming a part of the server computing device 102 may adaptively update an intelligent structural fabric unit to generate a morphed intelligent structural fabric unit based on the knowledge graph assembly. The intelligent structural fabric unit is generated based on the knowledge graph assembly and corresponds to semantically organized real-world entities associated with the AEC project.

In some embodiments, the monitor 118 is able to be programmed to receive feedback that may be used to execute corrections and alterations at the controller 114 side to fine tune decision making. Example feedback may correspond to decision parameters that may be manually provided by the user via an input interface (e.g., a graphical user interface) about issues and problems, such as construction status, delays, and the like, or may be automatically determined by the monitor 118. In an example, the current status regarding the construction may be compared by the monitor 118 with an earlier devised proposal to detect deviations and thereby detect the issues and problems. For such purposes, the monitor 118 is also programmed to receive data feeds from one or more external sources, such as on-site sensors or videos, and to store the data feeds in a data repository at the intelligent warehouse 108.

In some embodiments, the modifier 120 and/or the SFU module 220 is able to be programmed to receive modification data to update existing artificial intelligence models and the intelligent structural fabric units, in the network computing system 100 and to add new structural fabric models to the network computing system 100. Modification data may be provided as input by the user via an input interface (e.g., the graphical user interface). Modifications may also be sensed automatically through state-of-the-art sensors such as an acoustic or imaging sensor. In an example, the sensors may be configured as system on chip (SoC) and comprise electronics to log the user-inputs as received over a period of time and monitor trends within the logged inputs. In case of significant deviations or anomalies within the incoming input or between the incoming input and output as finally generated, an alert or trigger may be provided, for example, as feedback to update existing AI models to compensate for the sensed anomalies and deviations.

In some embodiments, the knowledge management module 208 is able to automatically determine the decision parameters and execute corrections and alterations at the controller 114 side to fine tune decision making. The decision parameters may be automatically determined by the knowledge management module 208 based on the data inputs received from one or more of the project objective 204, the user request 206, the disparate data sources 106, the intelligent warehouse 108, and the model ensemble 112. For example, an existing structural fabric unit that corresponds to installing window panels to be installed in two days, the knowledge management module 208 may determine that the window panel is not arriving in next two days from supplier ‘A’ and the user intent is to get the installation done positively in time. The knowledge management module 208 may further determine that the same window panel can be procured from a supplier ‘B’ by next day. Accordingly, the corresponding decision parameter may be tuned with the details of supplier ‘B’ instead of the supplier ‘A’ and the corresponding intelligent structural fabric unit may be adaptively morphed based on the new supplier details.

In some embodiments, the captive agents of the AI colony may be updated to morphed agents based on the knowledge units, such that the goals assigned to the morphed agents may correspond to the project objective of the construction project. Further, the one or more intermediary outputs may be updated to one or more morphed intermediary outputs. These one or more morphed intermediary outputs may be analyzed in a weighted combination to generate a plurality of morphed core knowledge segments. Further, a supervisory algorithm may assemble the plurality of morphed core knowledge segments based on the project objective to generate the morphed knowledge graph assembly. In some embodiments, the plurality of morphed core knowledge segments in the morphed knowledge graph assembly are associated with a plurality of dimensions and a plurality of modalities.

At step 412, the controller 114 forming a part of the server computing device 102 may deliver the morphed intelligent structural fabric unit in one or more formats to a client computing device, such as the client computing device 104, via an output interface. The one or more formats may be interactively rendered on a graphical user interface, such as in a browser or a client application. The one or more formats may include a report, a list of construction activities to be completed with corresponding predicted time durations, required resources, and other parameters (such as cost), and 2-D or 3-D graphical representation showing the current progress of the project, any deviation associated with timeline, budget, resources, and the like. The visualization of the one or more formats may be filtered by different factors, such as resources, and/or other parameters (i.e., time, cost, and the like).

Each construction activity may include one or more tasks, each task including a start data and a duration time. The construction activities are listed as a sequence of events. The example schedule also includes a graphical timeline showing tasks to be completed for each activity. Details of each tasks may be shown, such as in an overlay, by activating the task in the timeline (e.g., mouse-over, double-clicking, etc.). Details may include information relating to recommended contractors and suppliers.

FIG. 4B illustrates another method 400B for generating intelligent structural fabric units, in accordance with embodiments of the present disclosure. FIG. 4B will be explained in conjunction with the description of FIGS. 1 to 4A.

At step 420, the knowledge catalog module 270 in the SFU module 220 may associate metadata with the intelligent knowledge units based on discovery of relationships between the intelligent knowledge units. The metadata may comprise, for example, data lineage, data quality, usage statistics, attribute data, and property data, associated with the intelligent knowledge units. The metadata may be determined based on iterative analysis of data from one or more of the project objective 204, the user request 206, the disparate data sources 108, the intelligent warehouse 108, and the model ensemble 112.

At step 422, the classification module 272 in the SFU module 220 may analyze and classify the metadata associated with the intelligent knowledge units based on one or more classification techniques. For example, the metadata may be classified as technical (such as row/column count, data type, schema, and the like), governance (such as ownership, governance terms, and the like), operational (such as dependencies, runtime, and the like), collaboration (such as comments, discussion, and the like), quality (such as dataset status, test runs, and the like), and usage (such as view count, preferences, and the like).

At step 424, the structural orchestration module 274 in the SFU module 220 may generate a predictively relevant data mesh corresponding to a portion of the knowledge graph assembly based on the project objective 204 and the user request 206. The predictively relevant data mesh represents the intelligent structural fabric unit, as illustrated in FIGS. 3A to 3B.

FIG. 5 is a block diagram that illustrates an example computer system according to some embodiments. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

In some embodiments, the computer system 500 may be implemented within or correspond to the server computing device 102, the intelligent warehouse 108, or other associated hardware unit(s) (not shown herein) in a distributed manner. The computer system 500 includes an input/output (I/O) subsystem 502 which is able to include a bus and/or other communication mechanism(s) for communicating information and/or instructions between the components of the computer system 500 over electronic signal paths. The I/O subsystem 502 is able to include an I/O controller, a memory controller and at least one I/O port. The electronic signal paths are represented schematically in the drawings, for example as lines, unidirectional arrows, or bidirectional arrows.

At least one hardware processor 504 is coupled to the I/O subsystem 502 for processing information and instructions. The hardware processor 504 is able to include, for example, a general-purpose microprocessor or microcontroller and/or a special-purpose microprocessor such as an embedded system or a graphics processing unit (GPU) or a digital signal processor or ARM processor. The processor 504 is able to comprise an integrated arithmetic logic unit (ALU) or is able to be coupled to a separate ALU.

The computer system 500 includes one or more units of memory 506, such as a main memory, which is coupled to the I/O subsystem 502 for electronically digitally storing data and instructions to be executed by the processor 504. The memory 506 is able to include volatile memory such as various forms of RAM or other dynamic storage devices. The memory 506 is able to also be used for storing temporary variables or other intermediate information during execution of instructions to be executed by the processor 504. Such instructions, when stored in non-transitory computer-readable storage media accessible to the processor 504, are able to render computer system 500 into a special-purpose machine that is customized to perform the operations specified in the instructions.

The computer system 500 further includes non-volatile memory such as a read only memory (ROM) 508 or other static storage devices coupled to the I/O subsystem 502 for storing information and instructions for the processor 504. The ROM 508 is able to include various forms of programmable ROM (PROM) such as erasable PROM (EPROM) or electrically erasable PROM (EEPROM). A unit of persistent storage 510 is able to include various forms of non-volatile RAM (NVRAM), such as FLASH memory, or solid-state storage, magnetic disk, or optical disk such as CD-ROM or DVD-ROM and is able to be coupled to the I/O subsystem 502 for storing information and instructions. The storage 510 is an example of a non-transitory computer-readable medium that is able to be used to store instructions and data which when executed by the processor 504 cause performing computer-implemented methods to execute the techniques herein.

The instructions in the memory 506, the ROM 508 or the storage 510 are able to comprise one or more sets of instructions that are organized as modules, methods, objects, functions, routines, or calls. The instructions are able to be organized as one or more computer programs, operating system services, or application programs including mobile apps. The instructions are able to comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions are able to implement a web server, web application server or web client. The instructions are able to be organized as a presentation layer, application layer and data storage layer such as a relational database system using structured query language (SQL) or no SQL, an object store, a graph database, a flat file system or other data storage.

The computer system 500 is able to be coupled via I/O subsystem 502 to at least one output device 512. In some embodiments, the output device 512 is a digital computer display. Examples of a display that are able to be used in various embodiments include a touch screen display or a light-emitting diode (LED) display or a liquid crystal display (LCD) or an e-paper display. The computer system 500 is able to include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators, or servos.

At least one input device 514 is coupled to the I/O subsystem 502 for communicating signals, data, command selections or gestures to processor 504. Examples of the input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which is able to perform cursor control or other automated control functions such as navigation in a graphical interface on a display screen, alternatively or in addition to input functions. The control device 516 is able to be a touchpad, a mouse, a trackball, or cursor direction keys for communicating direction information and command selections to the processor 504 and for controlling cursor movement on a display. The control device 516 is able to have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 is able to include a combination of multiple different input devices, such as a video camera and a depth sensor.

In some embodiments, the computer system 500 is able to comprise an internet of things (IoT) device in which one or more of the output device 512, the input device 514, and the control device 516 are omitted. Or, in such embodiments, the input device 514 is able to comprise one or more cameras, motion detectors, thermometers, microphones, seismic detectors, other sensors or detectors, measurement devices or encoders and the output device 512 is able to comprise a special-purpose display such as a single-line LED or LCD display, one or more indicators, a display panel, a meter, a valve, a solenoid, an actuator or a servo.

When the computer system 500 is a mobile computing device, the input device 514 is able to comprise a global positioning system (GPS) receiver coupled to a GPS module that is capable of triangulating to a plurality of GPS satellites, determining and generating geo-location or position data such as latitude-longitude values for a geophysical location of the computer system 500. The output device 512 is able to include hardware, software, firmware, and interfaces for generating position reporting packets, notifications, pulse or heartbeat signals, or other recurring data transmissions that specify a position of the computer system 500, alone or in combination with other application-specific data, directed toward the host 524 or the server 530.

The computer system 500 is able to implement the techniques described herein using customized hard-wired logic, at least one ASIC or FPGA, firmware and/or program instructions or logic which when loaded and used or executed in combination with the computer system causes or programs the computer system to operate as a special-purpose machine. According to some embodiments, the techniques herein are performed by the computer system 500 in response to the processor 504 executing at least one sequence of at least one instruction contained in the main memory 506. Such instructions are able to be read into the main memory 506 from another storage medium, such as the storage 510. Execution of the sequences of instructions contained in the main memory 506 causes the processor 504 to perform the process steps described herein. In alternative embodiments, hard-wired circuitry is able to be used in place of or in combination with software instructions.

The term “storage media” as used herein refers to any non-transitory media that store data and/or instructions that cause a machine to operate in a specific fashion. Such storage media is able to comprise non-volatile media and/or volatile media. Non-volatile media includes, for example, optical or magnetic disks, such as the storage 510. Volatile media includes dynamic memory, such as the memory 506. Common forms of storage media include, for example, a hard disk, solid state drive, flash drive, magnetic data storage medium, any optical or physical data storage medium, memory chip, or the like.

Storage media is distinct from but is able to be used in conjunction with transmission media. Transmission media participates in transferring information between storage media. For example, transmission media includes coaxial cables, copper wire and fiber optics, including the wires that comprise a bus of the I/O subsystem 502. Transmission media is also able to take the form of acoustic or light waves, such as those generated during radio-wave and infra-red data communications.

Various forms of media are able to be involved in carrying at least one sequence of at least one instruction to the processor 504 for execution. For example, the instructions are able to initially be carried on a magnetic disk or solid-state drive of a remote computer. The remote computer is able to load the instructions into its dynamic memory and send the instructions over a communication link such as a fiber optic or coaxial cable or telephone line using a modem. A modem or router local to the computer system 500 is able to receive the data on the communication link and convert the data to a format that is able to be read by the computer system 500. For instance, a receiver such as a radio frequency antenna or an infrared detector is able to receive the data carried in a wireless or optical signal and appropriate circuitry is able to provide the data to the I/O subsystem 502 such as by placing the data on a bus. The I/O subsystem 502 carries the data to the memory 506, from which the processor 504 retrieves and executes the instructions. The instructions received by the memory 506 are able to optionally be stored on the storage 510 either before or after execution by the processor 504.

The computer system 500 also includes a communication interface 518 coupled to the bus on the I/O subsystem 502. The communication interface 518 provides two-way data communication coupling to the network link(s) 520 that are directly or indirectly coupled to at least one communication network, such as a network 522 or a public or private cloud on the Internet. For example, the communication interface 518 is able to be an Ethernet networking interface, integrated-services digital network (ISDN) card, cable modem, satellite modem, or a modem to provide a data communication coupling to a corresponding type of communications line, for example an Ethernet cable or a metal cable of any kind or a fiber-optic line or a telephone line. The network 522 broadly represents a local area network (LAN), wide-area network (WAN), campus network, internetwork, or any combination thereof. The communication interface 518 is able to comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, the communication interface 518 sends and receives electrical, electromagnetic, or optical signals over signal paths that carry digital data feeds representing various types of information.

The network link 520 typically provides electrical, electromagnetic, or optical data communication directly or through at least one network to other data devices, using, for example, satellite, cellular, Wi-Fi, or BLUETOOTH technology. For example, the network link 520 is able to provide a coupling through a network 522 to a host computer, such as a host 524.

Furthermore, the network link 520 is able to provide a coupling through the network 522 to other computing devices via internetworking devices and/or computers that are operated by an Internet Service Provider (ISP) 526. The ISP 526 provides data communication services through a world-wide packet data communication network represented as the Internet 528. The server computer 530 is able to be coupled to the Internet 528. The server 530 broadly represents any computer, data center, virtual machine, or virtual computing instance with or without a hypervisor, or computer executing a containerized program system such as DOCKER or KUBERNETES. The server 530 is able to represent an electronic digital service that is implemented using more than one computer or instance and that is accessed and used by transmitting web services requests, uniform resource locator (URL) strings with parameters in HTTP payloads, API calls, app services calls, or other service calls. The computer system 500 and the server 530 are able to form elements of a distributed computing system that includes other computers, a processing cluster, server farm or other organization of computers that cooperate to perform tasks or execute applications or services. The server 530 is able to comprise one or more sets of instructions that are organized as modules, methods, objects, functions, routines, or calls. The instructions are able to be organized as one or more computer programs, operating system services, or application programs including mobile apps. The instructions are able to comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The server 530 is able to comprise a web application server that hosts a presentation layer, application layer and data storage layer such as a relational database system using structured query language (SQL) or no SQL, an object store, a graph database, a flat file system or other data storage.

The computer system 500 is able to send messages and receive data and instructions, including program code, through the network(s), the network link 520 and the communication interface 518. In the Internet example, a server 530 might transmit a requested code for an application program through the Internet 528, the ISP 526, the local network 522 and the communication interface 518. The received code is able to be executed by the processor 504 as it is received, and/or stored in the storage 510, or other non-volatile storage for later execution.

The execution of instructions as described in this section is able to implement a process in the form of an instance of a computer program that is being executed and consisting of program code and its current activity. Depending on the operating system (OS), a process is able to be composed of multiple threads of execution that execute instructions concurrently. In this context, a computer program is a passive collection of instructions, while a process is able to be the actual execution of those instructions. Several processes are able to be associated with the same program; for example, opening up several instances of the same program often means more than one process is being executed. Multitasking is able to be implemented to allow multiple processes to share the processor 504. While each processor 504 or core of the processor executes a single task at a time, the computer system 500 is able to be programmed to implement multitasking to allow each processor to switch between tasks that are being executed without having to wait for each task to finish. In some embodiments, switches are able to be performed when tasks perform input/output operations, when a task indicates that it can be switched, or on hardware interrupts. Time-sharing is able to be implemented to allow fast response for interactive user applications by rapidly performing context switches to provide the appearance of concurrent execution of multiple processes simultaneously. In some embodiments, for security and reliability, an operating system is able to prevent direct communication between independent processes, providing strictly mediated and controlled inter-process communication functionality.

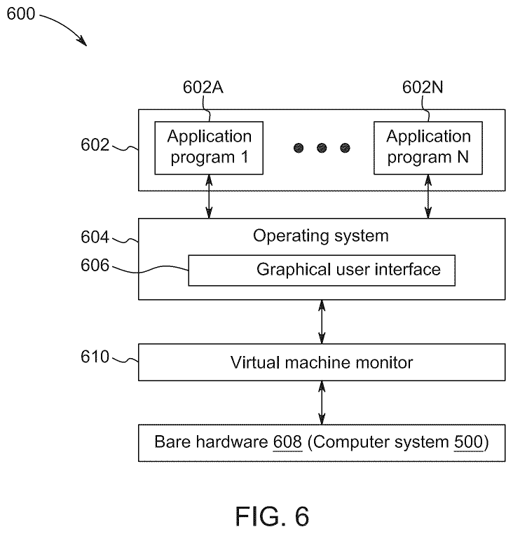

FIG. 6 is a block diagram of a basic software system 600 that is able to be employed for controlling the operation of the computer system 500, according to some embodiments. The software system 600 and its components, including their connections, relationships, and functions, is meant to be for an example only, and not meant to limit implementations of the example embodiment(s). Other software systems suitable for implementing the example embodiment(s) are able to have different components, including components with different connections, relationships, and functions.

The software system 600 is provided for directing the operation of the computer system 500. The software system 600, which is able to be stored in the system memory (RAM) 506 and on the fixed storage 510 (e.g., hard disk or flash memory), includes a kernel or operating system (OS) 604.

The OS 604 manages low-level aspects of computer operation, including managing execution of processes, memory allocation, file input and output (I/O), and device I/O. One or more application programs, represented as 602A, . . . , 602N (collectively, application(s) 602), are able to be “loaded” (e.g., transferred from fixed storage 510 into memory 506) for execution by the software system 600. The applications or other software intended for use on a device are also able to be stored as a set of downloadable computer-executable instructions, for example, for downloading and installation from an Internet location (e.g., a Web server, an app store, or other online service).

The software system 600 includes a graphical user interface (GUI) 606, for receiving user commands and data in a graphical (e.g., “point-and-click” or “touch gesture”) fashion. These inputs, in turn, are able to be acted upon by the software system 600 in accordance with instructions from the OS 604 and/or the application(s) 602. The GUI 606 also serves to display the results of operation from the OS 604 and application(s) 602, whereupon the user is able to supply additional input or terminate the session (e.g., log off).

The OS 604 is able to execute directly on the bare hardware 608 (e.g., processor(s) 504) of the computer system 500. Alternatively, a hypervisor or virtual machine monitor (VMM) 610 is able to be interposed between the bare hardware 608 and the OS 604. In this configuration, the VMM 610 acts as a software “cushion” or virtualization layer between the OS 604 and the bare hardware 608 of the computer system 500.

The VMM 610 instantiates and runs one or more virtual machine instances (“guest machines”). Each guest machine comprises a “guest” operating system, such as the OS 604, and one or more applications, such as the application(s) 602, designed to execute on the guest operating system. The VMM 610 presents the guest operating systems with a virtual operating platform and manages the execution of the guest operating systems.

In some instances, the VMM 610 is able to allow a guest operating system to run as if it is running directly on the bare hardware 608. In these instances, the same version of the guest operating system configured to execute on the bare hardware 608 directly is also able to execute on VMM 610 without modification or reconfiguration. In other words, the VMM 610 is able to provide full hardware and CPU virtualization to a guest operating system in some instances.

In other instances, a guest operating system is able to be specially designed or configured to execute the VMM 610 for efficiency. In these instances, the guest operating system is “aware” that it executes on a virtual machine monitor. In other words, the VMM 610 is able to provide para-virtualization to a guest operating system in some instances.

The above-described basic computer hardware and software is presented for the purpose of illustrating the basic underlying computer components that are able to be employed for implementing the example embodiment(s). The example embodiment(s), however, are not necessarily limited to any particular computing environment or computing device configuration. Instead, the example embodiment(s) are able to be implemented in any type of system architecture or processing environment that one skilled in the art, in light of this disclosure, would understand as capable of supporting the features and functions of the example embodiment(s) presented herein.

In some embodiments, one or more computer-readable storage media are able to be utilized in implementing embodiments consistent with the present disclosure. A computer-readable storage medium refers to any type of physical memory on which information or data readable by a processor is able to be stored. Thus, a computer-readable storage medium is able to store instructions for execution by one or more processors, including instructions for causing the processor(s) to perform steps or stages consistent with the embodiments described herein. The term “computer-readable medium” should be understood to include tangible items and exclude carrier waves and transient signals, for example, be non-transitory. Examples include RAM, ROM, volatile memory, nonvolatile memory, hard drives, CD ROMs, DVDs, flash drives, disks, and any other known physical storage media.

According to some embodiments, the techniques described herein are implemented by at least one computing device. The techniques are able to be implemented in whole or in part using a combination of at least one of the server computing device 102, the client computing device 104, and/or other computing devices that are coupled to the communication network 110 using a network, such as a packet data network. The computing devices are able to be hard-wired to perform the techniques or are able to include digital electronic devices such as at least one ASIC or FPGA that is persistently programmed to perform the techniques or are able to include at least one general purpose hardware processor programmed to perform the techniques pursuant to program instructions in firmware, memory, other storage, or a combination. Such computing devices are also able to combine custom hard-wired logic, ASICs, or FPGAs with custom programming to accomplish the described techniques. The computing devices are able to be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

The terms “comprising,” “including,” and “having,” as used in the claim and specification herein, shall be considered as indicating an open group that is able to include other elements not specified. The terms “a,” “an,” and the singular forms of words shall be taken to include the plural form of the same words, such that the terms mean that one or more of something is provided. The term “one” or “single” is able to be used to indicate that one and only one of something is intended. Similarly, other specific integer values, such as “two,” are able to be used when a specific number of things is intended. The terms “preferably,” “preferred,” “prefer,” “optionally,” “may,” and similar terms are used to indicate that an item, condition, or step being referred to is an optional (not required) feature of the invention.

The claimed invention has been described with reference to various specific and preferred embodiments and techniques. However, it should be understood that many variations and modifications are able to be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this claimed invention. Whenever a range is disclosed, all subranges and individual values are intended to be encompassed. This claimed invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that are able to be individually or together applied to any other embodiment shown or contemplated here to be mixed and matched with the features of such networks, devices, and/or modules.

While the claimed invention has been described with respect to a limited number of embodiments, those skilled in the art, having benefit of this disclosure, will appreciate that other embodiments are able to be devised which do not depart from the scope of the invention as disclosed herein.

We claim:

1. A computer-implemented method for managing construction projects using knowledge graph-based structural fabric units, comprising:
receiving a user request corresponding to a project objective associated with a construction project in a construction environment;
obtaining a plurality of data feeds from a plurality of disparate data sources for a construction phase based on the project objective and a user intent identified from the user request;
applying a plurality of ensembles of machine learning models to each of the plurality of data feeds to generate a plurality of knowledge units based on the user request, wherein each of the plurality of ensembles of the machine learning models is trained using data related to the construction project, wherein the plurality of knowledge units are assembled in a knowledge graph assembly;
adaptively updating a structural fabric unit to generate a morphed structural fabric unit based on the knowledge graph assembly, wherein the structural fabric unit corresponds to semantically organized real-world entities associated with the construction project; and
notifying the morphed structural fabric unit in one or more formats to a client computing device via an output interface.

2. The computer-implemented method of claim 1, further comprising generating organizational knowledge units based on the knowledge graph assembly, proprietary information, and knowledge components specific to an organization.

3. The computer-implemented method of claim 2, wherein the generation of the structural fabric unit for the construction project is further based on the generated organizational knowledge units.

4. The computer-implemented method of claim 1, wherein generating the structural fabric unit for the construction project comprises:
associating metadata with the knowledge units based on discovery of relationships between the knowledge units, wherein the metadata comprises at least attribute data and property data associated with the knowledge units;
analyzing and classifying the metadata associated with the knowledge units based on one or more classification techniques; and
generating a predictively relevant data mesh corresponding to a portion of the knowledge graph assembly based on the project objective and the user request, wherein the predictively relevant data mesh represents the structural fabric unit.

5. The computer-implemented method of claim 1, wherein the structural fabric unit corresponds to a plurality of self-composing real-world entities in the construction environment specific to at least the construction phase, a current time instant, and a set of metrics associated with the construction project, and
wherein the real-world entities comprise at least objects, structures, events, activities, resources, situations, and concepts in the construction environment.

6. The computer-implemented method of claim 1, further comprising evaluating one or more decision parameters during the construction phase and a time duration of the construction project.

7. The computer-implemented method of claim 6, wherein adaptively updating the structural fabric unit to generate the morphed structural fabric unit is based on the one or more decision parameters.

8. The computer-implemented method of claim 6, wherein the one or more decision parameters are associated with one or more of at least productivity metrics, anticipated weather conditions, topography, historical context, supplier details, contractor details, and milestone details.

9. The computer-implemented method of claim 1, further comprising generating the knowledge graph assembly in response to another project objective, wherein generating the knowledge graph assembly further comprises:
assigning one or more goals to one or more colonies of Artificial Intelligence (AI) colonizers, each colony of AI colonizers comprising a lead colonizer and a plurality of captive agents navigating collectively towards the one or more goals to generate one or more intermediary outputs, wherein the one or more goals correspond to the other project objective;
analyzing the one or more intermediary outputs in a weighted combination to generate a plurality of core knowledge segments; and
assembling, by a supervisory algorithm, the plurality of core knowledge segments to generate the knowledge graph assembly.

10. The computer-implemented method of claim 9, further comprising:
updating the plurality of captive agents to a plurality of morphed agents based on the plurality of knowledge units, wherein the one or more goals correspond to the project objective of the construction project;
updating the one or more intermediary outputs to one or more morphed intermediary outputs;
analyzing the one or more morphed intermediary outputs in a weighted combination to generate a plurality of morphed core knowledge segments; and
assembling, by the supervisory algorithm, the plurality of morphed core knowledge segments based on the project objective to generate the morphed knowledge graph assembly.

11. The computer-implemented method of claim 10, wherein the plurality of morphed core knowledge segments in the morphed knowledge graph assembly are associated with a plurality of dimensions and a plurality of modalities.

12. A system for managing construction projects using knowledge graph-based structural fabric units, the system comprising:
a controller configured to:
receive a user request corresponding to a project objective associated with a construction project in a construction environment;
obtain a plurality of data feeds from a plurality of disparate data sources for a construction phase based on the project objective and a user intent identified from the user request;
apply a plurality of ensembles of machine learning models to each of the plurality of data feeds to generate a plurality of knowledge units based on the user request, wherein each of the plurality of ensembles of the machine learning models is trained using data related to the construction project, wherein the plurality of knowledge units are assembled in a knowledge graph assembly;
adaptively update a structural fabric unit to generate a morphed structural fabric unit based on the knowledge graph assembly, wherein the structural fabric unit corresponds to semantically organized real-world entities associated with the construction project; and
notify the morphed structural fabric unit in one or more formats to a client computing device via an output interface.

13. The system of claim 12, wherein the controller is further configured to generate organizational knowledge units based on the knowledge graph assembly, proprietary information, and knowledge components specific to an organization.

14. The system of claim 13, wherein the controller is further configured to generate the structural fabric unit for the construction project based on the organizational knowledge units.

15. The system of claim 12, wherein the controller is further configured to:
associate metadata with the knowledge units based on discovery of relationships between the knowledge units, wherein the metadata comprises at least attribute data and property data associated with the knowledge units;
analyze and classify the metadata associated with the knowledge units based on one or more classification techniques; and
generate a predictively relevant data mesh corresponding to a portion of the knowledge graph assembly based on the project objective and the user request, wherein the predictively relevant data mesh represents the structural fabric unit.

16. The system of claim 12, wherein the structural fabric unit corresponds to a plurality of self-composing real-world entities in the construction environment specific to at least the construction phase, a current time instant, and a set of metrics associated with the construction project, and
wherein the real-world entities comprise at least objects, structures, events, activities, resources, situations, and concepts in the construction environment.

17. The system of claim 12, wherein the controller is further configured to evaluate one or more decision parameters during the construction phase and a time duration of the construction project.

18. The system of claim 12, wherein the controller is further configured to adaptively update the structural fabric unit to generate the morphed structural fabric unit based on the one or more decision parameters.

19. The system of claim 18, wherein the one or more decision parameters are associated with one or more of at least productivity metrics, anticipated weather conditions, topography, historical context, supplier details, contractor details, and milestone details.

20. A non-transitory computer-readable storage medium, having stored thereon a computer-executable program which, when executed by at least one processor, causes the at least one processor to:
receive a user request corresponding to a project objective associated with a construction project in a construction environment;
obtain a plurality of data feeds from a plurality of disparate data sources for a construction phase based on the project objective and a user intent identified from the user request;
apply a plurality of ensembles of machine learning models to each of the plurality of data feeds to generate a plurality of knowledge units based on the user request, wherein each of the plurality of ensembles of the machine learning models is trained using data related to the construction project, wherein the plurality of knowledge units are assembled in a knowledge graph assembly;
adaptively update a structural fabric unit to generate a morphed structural fabric unit based on the knowledge graph assembly, wherein the structural fabric unit corresponds to semantically organized real-world entities associated with the construction project; and
notify the morphed structural fabric unit in one or more formats to a client computing device via an output interface.
